(19) United States
(12) Patent Application Publication
(10) Pub. No.: US 2026/0059528 A1
(43) Pub. Date: Feb. 26, 2026

(54) UPLINK RESOURCE MUTING PATTERN CONFIGURATION

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Abdelrahman Mohamed IBRAHIM, San Diego, CA (US); Yan ZHOU, San Diego, CA (US)

(21) Appl. No.: 19/065,216

(22) Filed: Feb. 27, 2025

Related U.S. Application Data
(60) Provisional application No. 63/685,628, filed on Aug. 21, 2024.

(51) Int. Cl. H04W 72/21; H04L 5/00; H04W 72/0446

(52) U.S. Cl. CPC H04W 72/21; H04L 5/0005; H04L 5/0048; H04W 72/0446

(57) ABSTRACT

Various aspects of the present disclosure generally relate to wireless communication. In some aspects, a user equipment (UE) may receive a configuration that indicates one or more uplink resource muting patterns based at least in part on one or more of a first physical uplink shared channel (PUSCH) resource mapping type or a second PUSCH resource mapping type. The UE may transmit a PUSCH transmission in accordance with the one or more uplink resource muting patterns. Numerous other aspects are described.

### CROSS-REFERENCE TO RELATED APPLICATION

This Patent Application claims priority to U.S. Provisional Patent Application No. 63/685,628, filed on August 21, 2024, entitled “UPLINK RESOURCE MUTING PATTERN CONFIGURATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for configuring uplink resource muting patterns.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some implementations, a method of wireless communication performed by a user equipment (UE) includes receiving a configuration that indicates one or more uplink resource muting patterns based at least in part on one or more of a first physical uplink shared channel (PUSCH) resource mapping type or a second PUSCH resource mapping type; and transmitting a PUSCH transmission in accordance with the one or more uplink resource muting patterns.

In some implementations, a method of wireless communication performed by a network node includes transmitting a configuration that indicates one or more uplink resource muting patterns based at least in part on one or more of a first PUSCH resource mapping type or a second PUSCH resource mapping type; and receiving a PUSCH transmission in accordance with the one or more uplink resource muting patterns.

In some implementations, an apparatus for wireless communication at a UE includes one or more memories; and one or more processors, coupled to the one or more memories, configured to cause the UE to: receive a configuration that indicates one or more uplink resource muting patterns based at least in part on one or more of a first PUSCH resource mapping type or a second PUSCH resource mapping type; and transmit a PUSCH transmission in accordance with the one or more uplink resource muting patterns.

In some implementations, an apparatus for wireless communication at a network node includes one or more memories; and one or more processors, coupled to the one or more memories, configured to cause the network node to: transmit a configuration that indicates one or more uplink resource muting patterns based at least in part on one or more of a first PUSCH resource mapping type or a second PUSCH resource mapping type; and receive a PUSCH transmission in accordance with the one or more uplink resource muting patterns.

In some implementations, a non-transitory computer-readable medium storing a set of instructions for wireless communication includes one or more instructions that, when executed by one or more processors of a UE, cause the UE to: receive a configuration that indicates one or more uplink resource muting patterns based at least in part on one or more of a first PUSCH resource mapping type or a second PUSCH resource mapping type; and transmit a PUSCH transmission in accordance with the one or more uplink resource muting patterns.

In some implementations, a non-transitory computer-readable medium storing a set of instructions for wireless communication includes one or more instructions that, when executed by one or more processors of a network node, cause the network node to: transmit a configuration that indicates one or more uplink resource muting patterns based at least in part on one or more of a first PUSCH resource mapping type or a second PUSCH resource mapping type; and receive a PUSCH transmission in accordance with the one or more uplink resource muting patterns.

In some implementations, an apparatus for wireless communication includes means for receiving a configuration that indicates one or more uplink resource muting patterns based at least in part on one or more of a first PUSCH resource mapping type or a second PUSCH resource mapping type; and means for transmitting a PUSCH transmission in accordance with the one or more uplink resource muting patterns.

In some implementations, an apparatus for wireless communication includes means for transmitting a configuration that indicates one or more uplink resource muting patterns based at least in part on one or more of a first PUSCH resource mapping type or a second PUSCH resource mapping type; and means for receiving a PUSCH transmission in accordance with the one or more uplink resource muting patterns.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full duplex (FD) communications, in accordance with the present disclosure.

FIG. 5 is a diagram illustrating examples of FD communications, in accordance with the present disclosure.

FIGS. 6-8 are diagrams illustrating examples of cross-link interference (CLI), in accordance with the present disclosure.

FIG. 9 is a diagram illustrating an example of uplink resource muting, in accordance with the present disclosure.

FIG. 10 is a diagram illustrating an example associated with configuring uplink resource muting patterns, in accordance with the present disclosure.

FIGS. 11-12 are diagrams illustrating example processes associated with configuring uplink resource muting patterns, in accordance with the present disclosure.

FIGS. 13-14 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

An uplink resource muting may be applied to a physical uplink shared channel (PUSCH). As part of the uplink resource muting, one or more resource elements (REs) associated with the PUSCH may be muted. The one or more REs associated with the PUSCH may be muted in accordance with an uplink resource muting pattern. When an RE is muted, that RE may not be used for a PUSCH transmission. For example, in a frequency domain, every other RE may be muted, and remaining REs in the frequency domain may be used for the PUSCH transmission. The muted REs may be used by a network node to handle cross-link interference (CLI). For example, the network node may perform CLI measurements during the muted REs, where such CLI measurements may be used to mitigate CLI between network nodes. A UE may be configured with the uplink resource muting, such that the UE does not perform the PUSCH transmission in the muted REs, such that the muted REs may be used by the network node for CLI handling.

A PUSCH resource mapping may be Type A or Type B. For a PUSCH resource mapping Type A, a demodulation reference signal (DMRS) may be configured at a fixed symbol location, e.g., symbol 3 of a slot. PUSCH data symbols may be mapped to a first symbol of the slot with a configured length. In other words, for the PUSCH resource mapping Type A, a DMRS location may be fixed to symbol 3, where a PUSCH starting symbol may always be symbol 0. For a PUSCH resource mapping Type B, a DMRS may be front loaded to PUSCH data symbols, where a start symbol and a length of a PUSCH may be configurable. In other words, for the PUSCH resource mapping Type B, a DMRS location may be fixed to a first symbol of an allocated PUSCH, where a PUSCH starting symbol may be symbol 0 to symbol 13.

However, when uplink resource muting is configured for a PUSCH, the uplink resource muting may not consider the PUSCH resource mapping. The uplink resource muting may not consider the PUSCH resource mapping Type A and the PUSCH resource mapping Type B. A UE may be indicated with the uplink resource muting via a semi-static configuration, but the uplink resource muting may not be based at least in part on the PUSCH resource mapping. As a result, when the PUSCH resource mapping Type A or the PUSCH resource mapping Type A is used, a UE may not be properly configured to employ the uplink resource muting, thereby degrading an overall system performance.

Various aspects relate generally to configuring uplink resource muting patterns. Some aspects more specifically relate to configuring uplink resource muting patterns based at least in part on PUSCH resource mapping types. In some examples, a UE may receive, from a network node, a configuration that indicates one or more uplink resource muting patterns based at least in part on a first PUSCH resource mapping type (e.g., Type A) or a second PUSCH resource mapping type (e.g., Type B). The one or more uplink resource muting patterns may be per PUSCH resource mapping type, where the PUSCH resource mapping type may include the first PUSCH resource mapping type or the second PUSCH resource mapping type. In some aspects, the configuration may indicate one uplink resource muting pattern for the first PUSCH resource mapping type and another uplink resource muting pattern for the second PUSCH resource mapping type. In some aspects, the configuration may indicate more than one uplink resource muting pattern for the first PUSCH resource mapping type and more than one uplink resource muting pattern for the second PUSCH resource mapping type. In some aspects, the configuration may indicate one uplink resource muting pattern for the first PUSCH resource mapping type and the second PUSCH resource mapping type. In some aspects, the configuration may indicate a plurality of uplink resource muting patterns that are common for the first PUSCH resource mapping type and the second PUSCH resource mapping type.

Particular aspects of the subject matter described in this disclosure can be implemented to realize one or more of the following potential advantages. In some examples, by configuring uplink resource muting patterns based at least in part on PUSCH resource mapping types, the described techniques can be used to enable the UE to use suitable uplink resource muting patterns that consider the PUSCH resource mapping type. Since different PUSCH resource mappings may be defined for Type A and Type B, different uplink resource muting patterns may be configured per PUSCH resource mapping type. The UE may be configured to apply a certain uplink resource muting pattern depending on an applicable type of PUSCH resource mapping, thereby improving an overall system performance. Without such a configuration, the UE may be unable to apply uplink resource muting, which would prevent the network node from using muted resources for purposes of CLI handling. With the configuration, the UE may successfully apply the uplink resource muting, thereby allowing the muted resources to become available for the CLI handling.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) user equipment (UE) functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

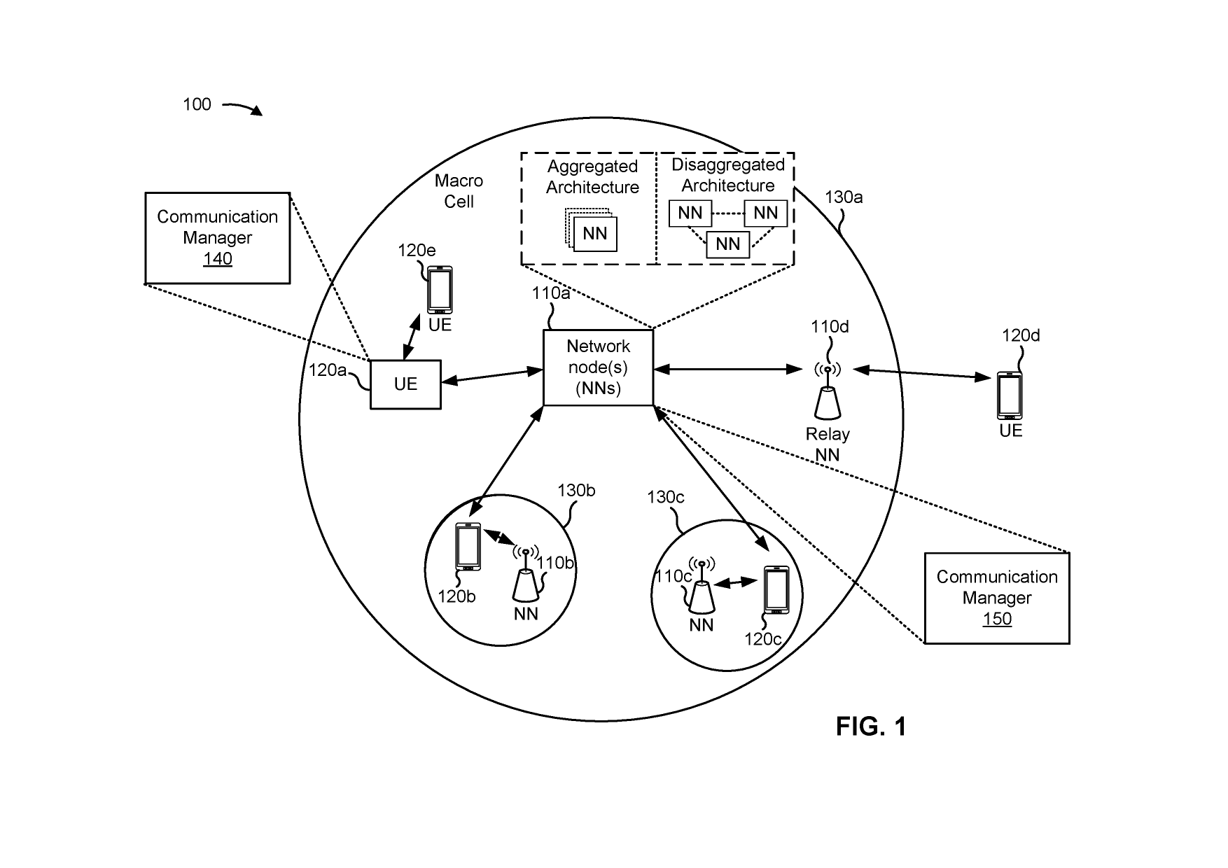

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c.Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more PUSCHs. The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., the UE 120) may include a communication manager 140. As described in more detail elsewhere herein, the communication manager 140 may receive a configuration that indicates one or more uplink resource muting patterns based at least in part on one or more of a first PUSCH resource mapping type or a second PUSCH resource mapping type; and transmit a PUSCH transmission in accordance with the one or more uplink resource muting patterns. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit a configuration that indicates one or more uplink resource muting patterns based at least in part on one or more of a first PUSCH resource mapping type or a second PUSCH resource mapping type; and receive a PUSCH transmission in accordance with the one or more uplink resource muting patterns. Additionally, or alternatively, the communication manager 150 may perform one or more other operations described herein.

As indicated above, FIG. 1 is provided as an example. Other examples may differ from what is described with regard to FIG. 1.

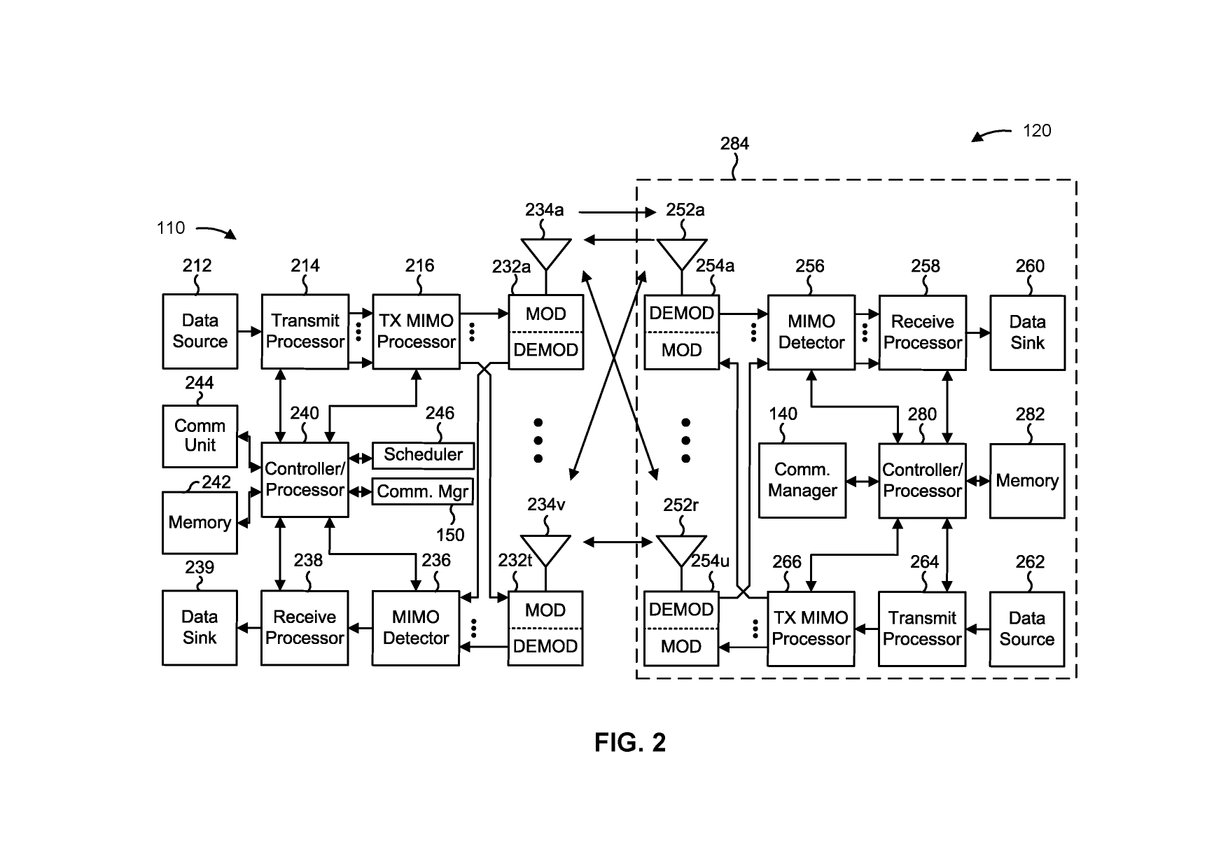

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t ≥ 1), a set of antennas 234 (shown as 234a through 234v, where v ≥ 1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a DMRS, or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r ≥ 1), a set of modems 254 (shown as modems 254a through 254u, where u ≥ 1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

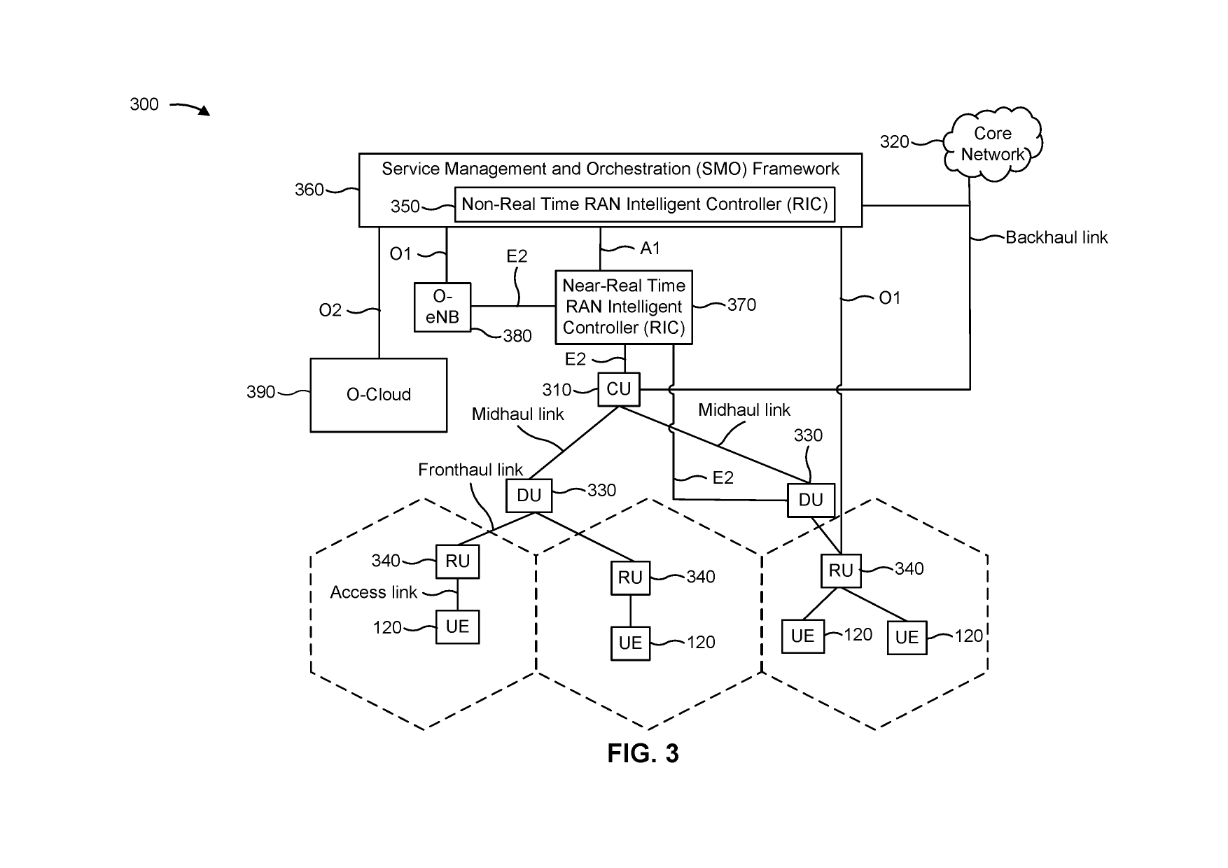

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

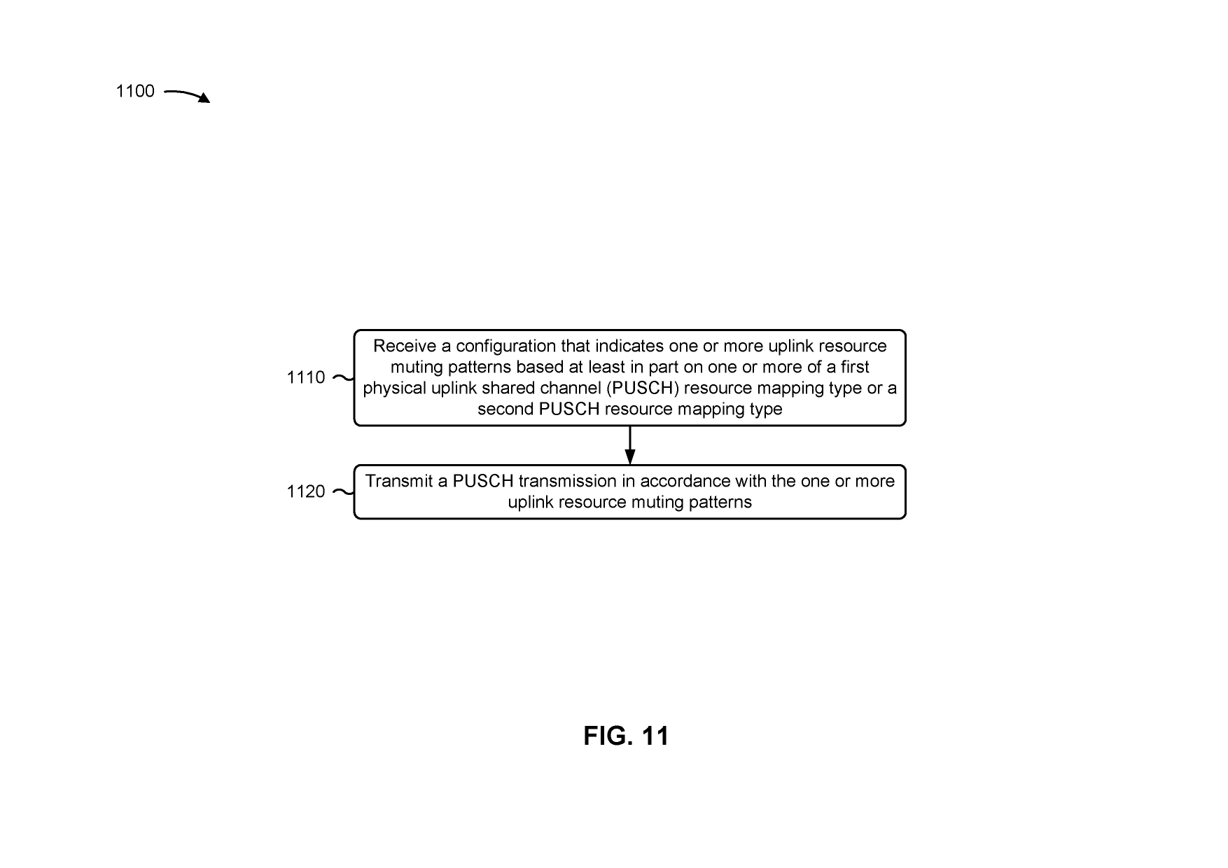

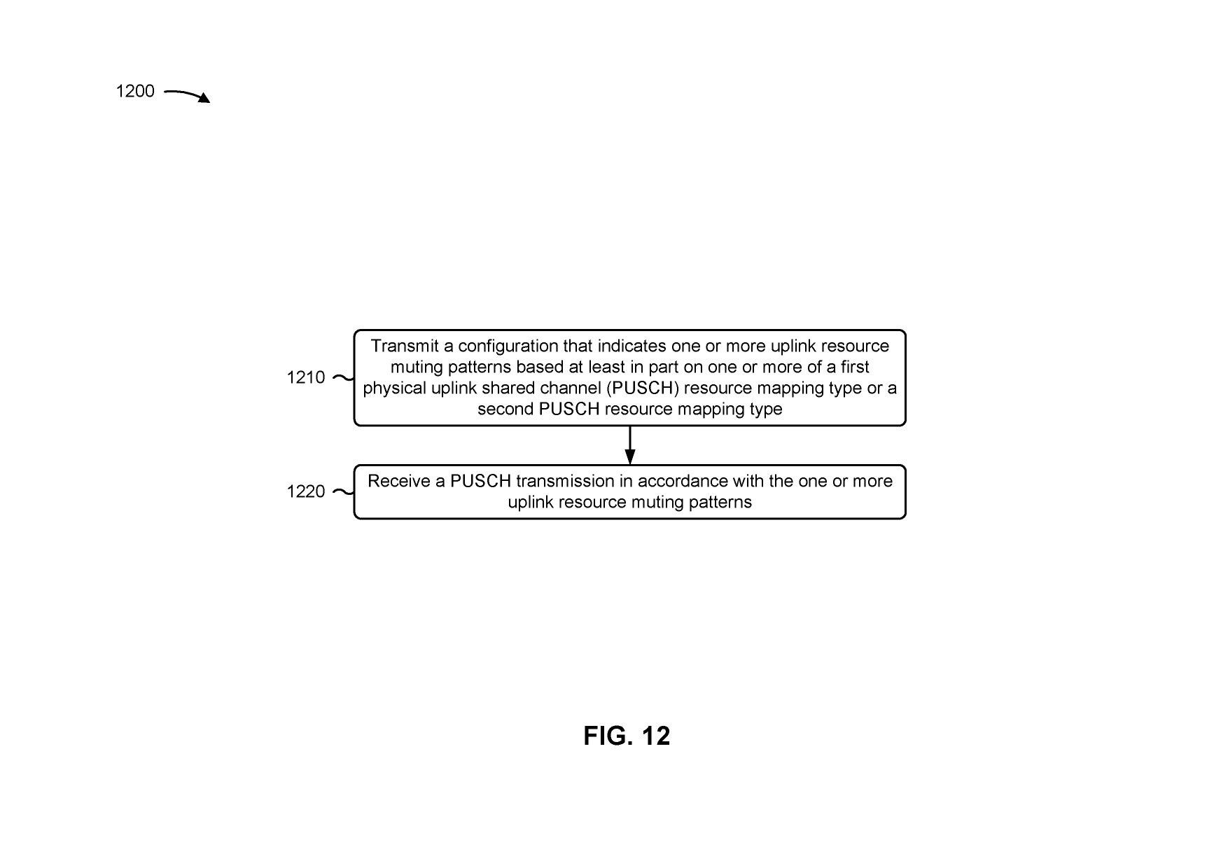

The network node 110, the controller/processor 240 of the network node 110, the UE 120, the controller/processor 280 of the UE 120, the CU 310, the DU 330, the RU 340, or any other component(s) of FIGS. 1, 2, or 3, may implement one or more techniques or perform one or more operations associated with configuring uplink resource muting patterns, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1100 of FIG. 11, process 1200 of FIG. 12, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

In some aspects, a UE (e.g., the UE 120) includes means for receiving a configuration that indicates one or more uplink resource muting patterns based at least in part on one or more of a first PUSCH resource mapping type or a second PUSCH resource mapping type; and/or means for transmitting a PUSCH transmission in accordance with the one or more uplink resource muting patterns. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting a configuration that indicates one or more uplink resource muting patterns based at least in part on one or more of a first PUSCH resource mapping type or a second PUSCH resource mapping type; and/or means for receiving a PUSCH transmission in accordance with the one or more uplink resource muting patterns. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

A full duplex (FD) operation may involve an in-band full duplex (IBFD) operation, in which a transmission and a reception may occur on the same time and frequency resource. A downlink direction and an uplink direction may share the same IBFD time/frequency resource based at least in part on a full or partial overlap. Alternatively, the FD operation may involve a subband full duplex (SBFD) operation (or flexible duplex), in which a transmission and a reception may occur at the same time but on different frequency resources. A downlink resource may be separated from an uplink resource in a frequency domain. In the SBFD operation, no downlink and uplink overlap in frequency may occur.

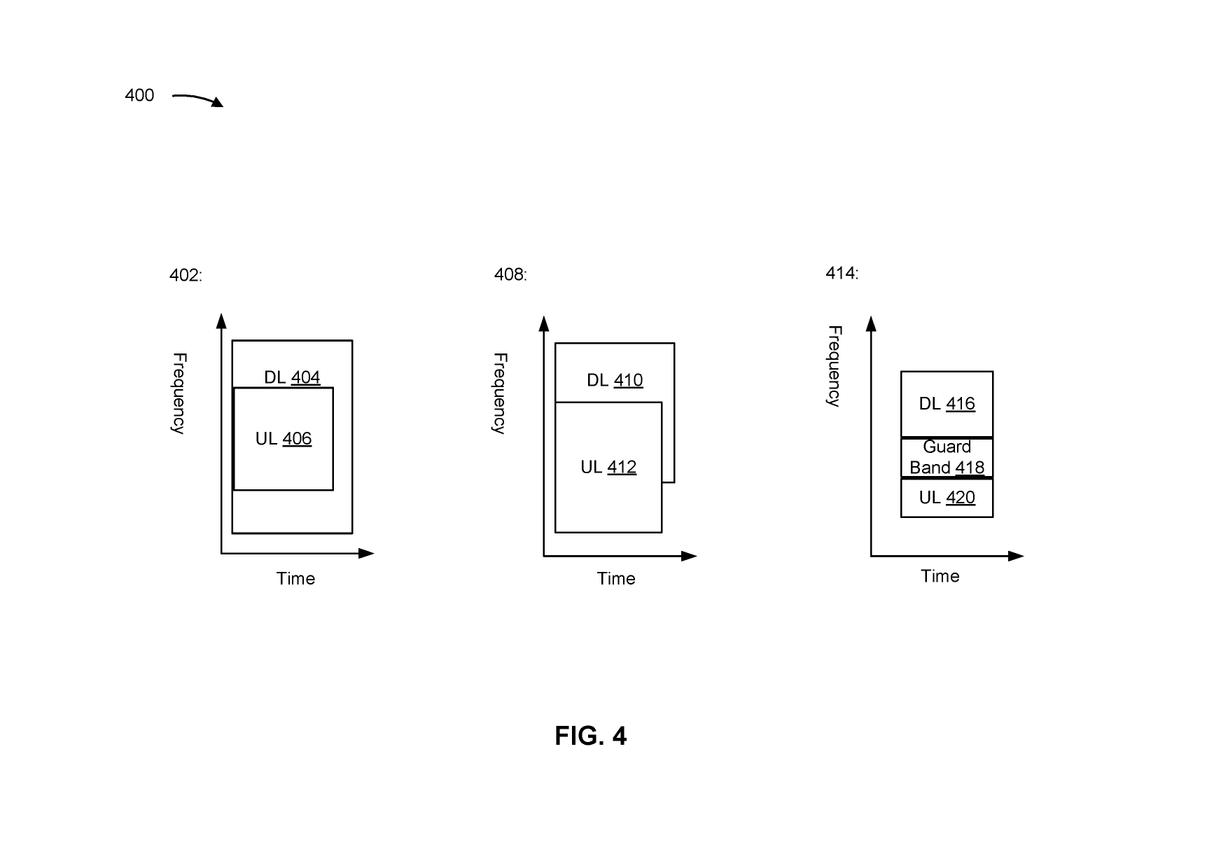

FIG. 4 is a diagram illustrating examples 400 of FD communications, in accordance with the present disclosure.

As shown by reference number 402, a downlink resource 404 and an uplink resource 406 may share the same IBFD time/frequency resource based at least in part on a full overlap. As shown by reference number 408, a downlink resource 410 and an uplink resource 412 may share the same IBFD time/frequency resource based at least in part on a partial overlap. As shown by reference number 414, a downlink resource 416 and an uplink resource 420 may be associated with a same time but different frequencies. The downlink resource 416 and the uplink resource 420 may be separated by a guard band 418.

As indicated above, FIG. 4 is provided as an example. Other examples may differ from what is described with regard to FIG. 4.

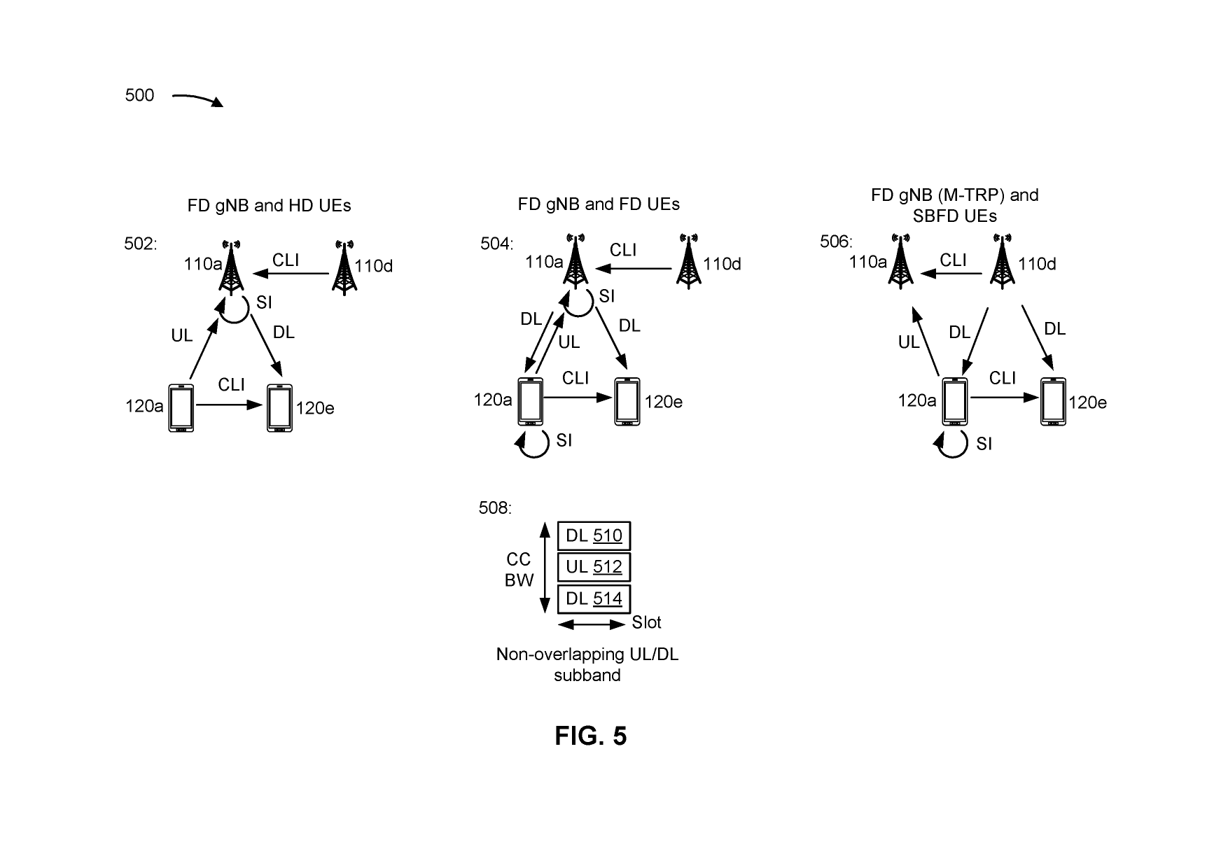

FIG. 5 is a diagram illustrating examples 500 of FD communications, in accordance with the present disclosure.

As shown by reference number 502, an FD network node (e.g., network node 110a) may communicate with half duplex (HD) UEs. The FD network node may be subjected to CLI from another FD network node (e.g., network node 110d). The CLI from the other FD network node may be inter-network node CLI. The FD network node may experience self-interference (SI). The FD network node may receive an uplink transmission from a first HD UE (e.g., UE 120a), and the FD network node may transmit a downlink transmission to a second HD UE (e.g., UE 120e). The FD network node may receive the uplink transmission and transmit the downlink transmission on the same slot (e.g., a simultaneous reception/transmission). The second HD UE may be subjected to CLIfrom the first HD UE (e.g., inter-UE CLI).

As shown by reference number 504, an FD network node (e.g., network node 110a) may communicate with FD UEs. The FD network node may be subjected to CLI from another FD network node (e.g., network node 110d). The FD network node may experience SI. The FD network node may transmit a downlink transmission to a first FD UE (e.g., UE 120a), and the FD network node may receive an uplink transmission from the first FD UE at the same time as the downlink transmission. The FD network node may transmit a downlink transmission to a second FD UE (e.g., UE 120e). The second HD UE may be subjected to CLI from the first HD UE. The first UE may experience SI.

As shown by reference number 506, a first FD network node (e.g., network node 110a), which may be associated with multiple transmission reception points (TRPs), may communicate with SBFD UEs. The first FD network node may be subjected to CLIfrom a second FD network node (e.g., network node 110s). The first FD network node may receive an uplink transmission from a first SBFD UE (e.g., UE 120a). The second FD network node may transmit downlink transmissions to both the first SBFD UE and a second SBFD UE (e.g., UE 120e). The second SBFD UE may be subjected to CLI from the first SBFD UE. The first SBFD UE may experience SI.

As shown by reference number 508, an SBFD slot may be associated with a non-overlapping uplink/downlink sub-band. The SBFD slot may be associated with a simultaneous transmission/reception of a downlink/uplink on a sub-band basis. Within a component carrier bandwidth, an uplink resource 512 may be in between, in a frequency domain, a first downlink resource 510 and a second downlink resource 514. The first downlink resource 510, the second downlink resource 514, and the uplink resource 512 may all be associated with the same time.

An SBFD operation may increase an uplink duty cycle, which may result in a latency reduction (e.g., a downlink signal may be received in uplink-only slots, which may enable latency savings) and uplink coverage improvement. The SBFD operation may improve a system capacity, resource utilization, and/or spectrum efficiency. The SBFD operation may enable a flexible and dynamic uplink/downlink resource adaption according to uplink/downlink traffic in a robust manner.

As indicated above, FIG. 5 is provided as an example. Other examples may differ from what is described with regard to FIG. 5.

When a UE is operating in an HD mode and a network node is operating in an SBFD/IBFD mode, various sources of interference may be present for the UE. The UE may experience inter-cell interference from other network nodes. The UE may experience intra-cell CLI, which may be interference from UEs in the same cell. The UE may experience inter-cell CLI, which may be interference from UEs in adjacent cells. Further, when the UE is an FD UE, the UE may experience SI (e.g., a downlink transmission of the UE may cause interference to an uplink transmission associated with the UE, or vice versa). Inter-UE CLI handling may resolve intra-subband CLI and/or inter-subband CLI in the case of subband non-overlapping FD.

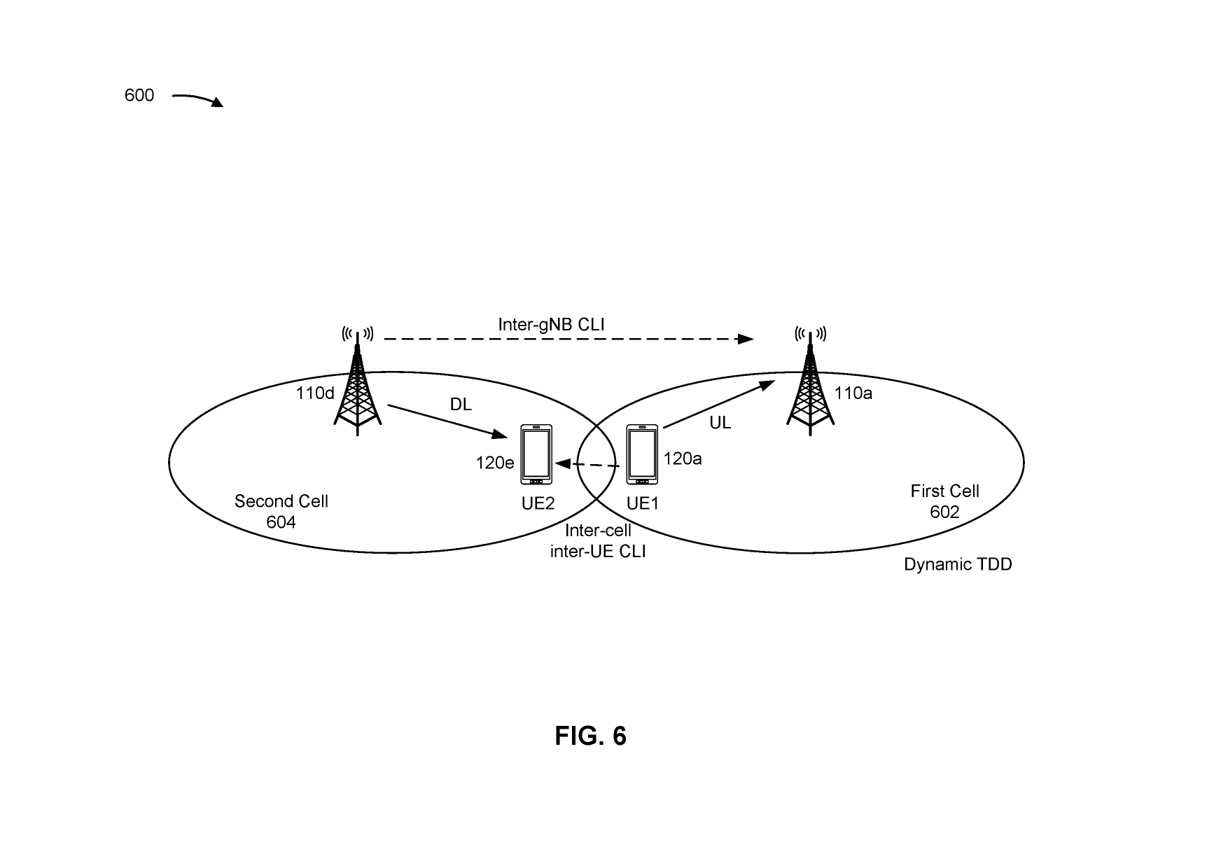

FIG. 6 is a diagram illustrating an example 600 of CLI, in accordance with the present disclosure.

As shown in FIG. 6, in a dynamic time domain duplexing (TDD) scenario, a first network node 110a in a first cell 602 may receive an uplink transmission from a first UE 120a. A second network node 110d in a second cell 604 may transmit a downlink transmission to a second UE 120e. The second UE 120e may experience interference from the first UE 120a. In other words, the first UE 120a may cause interference to the second UE 120e, where the interference may be based at least in part on the uplink transmission from the first UE 120a. The interference may be an inter-cell inter-UE CLI. Further, the first network node 110a may experience inter-network-node (e.g., inter-gNB) CLI from the second network node 110d.

As indicated above, FIG. 6 is provided as an example. Other examples may differ from what is described with regard to FIG. 6.

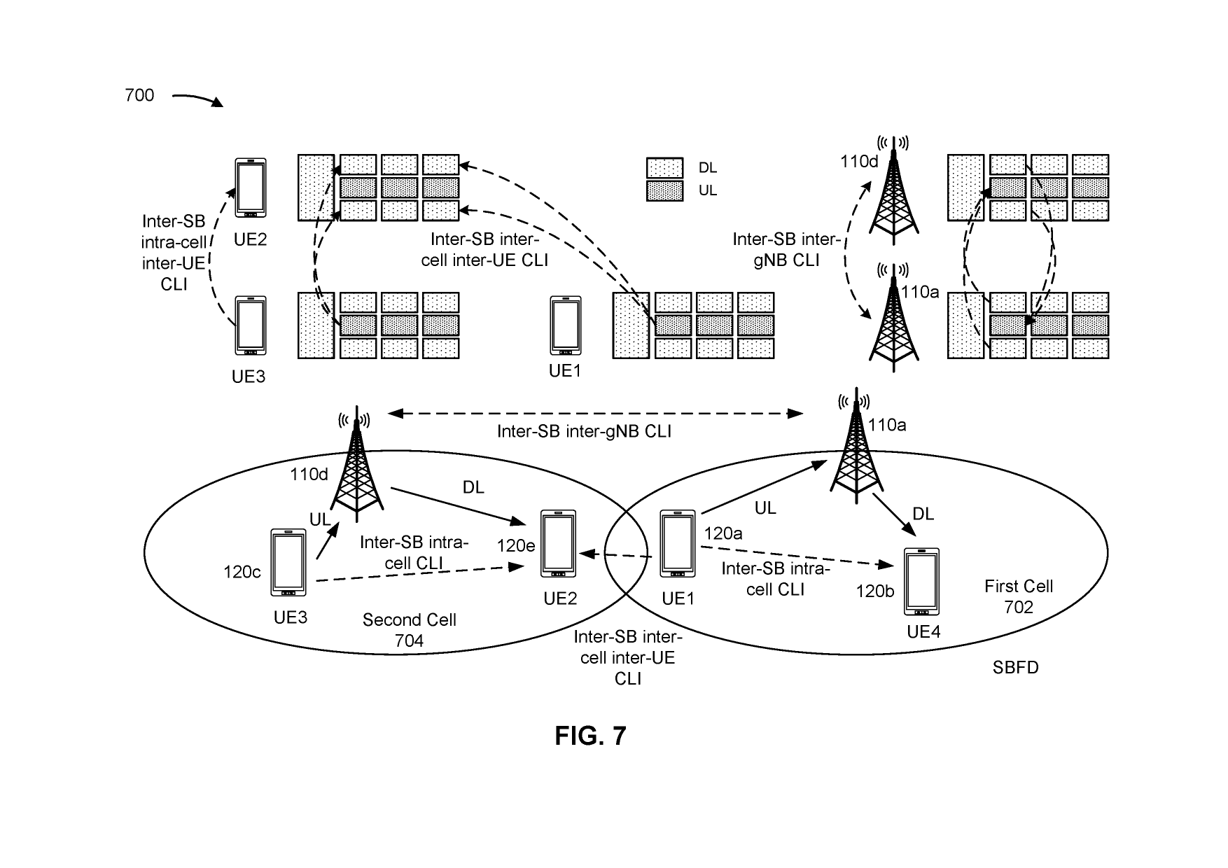

FIG. 7 is a diagram illustrating an example 700 of CLI, in accordance with the present disclosure.

As shown in FIG. 7, in an SBFD scenario, a first network node 110a in a first cell 702 may receive an uplink transmission from a first UE 120a in the first cell 702. The first network node 110a may transmit a downlink transmission to a fourth UE 120b in the first cell 702. The first UE 120a may cause an inter-subband (inter-SB) intra-cell CLI to the fourth UE 120b based at least in part on the uplink transmission of the first UE 120a. A second network node 110d in a second cell 704 may receive an uplink transmission from a third UE 120c in the second cell 704. The second network node 110d may transmit a downlink transmission to a second UE 120e in the second cell 704. The third UE 120c may cause an inter-SB intra-cell CLI to the second UE 120e based at least in part on the uplink transmission of the third UE 120c. The uplink transmission of the third UE 120c may cause the inter-SB intra-cell CLI to downlink transmissions of the second UE 120e. Further, the first UE 120a in the first cell 702 may cause an inter-SB inter-cell inter-UE CLI to the second UE 120e in the second cell 704 based at least in part on the uplink transmission of the first UE 120a. The uplink transmission of the first UE 120a may cause the inter-SB inter-cell inter-UE CLI to downlink transmissions of the second UE 120e. Further, the first network node 110a may cause an inter-SB inter-gNB CLI to the second network node 110d, and vice versa. Downlink transmissions of the first network node 110a may cause the inter-SB inter-gNB CLI to an uplink transmission of the second network node 110d. Downlink transmissions of the second network node 110d may cause the inter-SB inter-gNB CLI to an uplink transmission of the first network node 110a.

As indicated above, FIG. 7 is provided as an example. Other examples may differ from what is described with regard to FIG. 7.

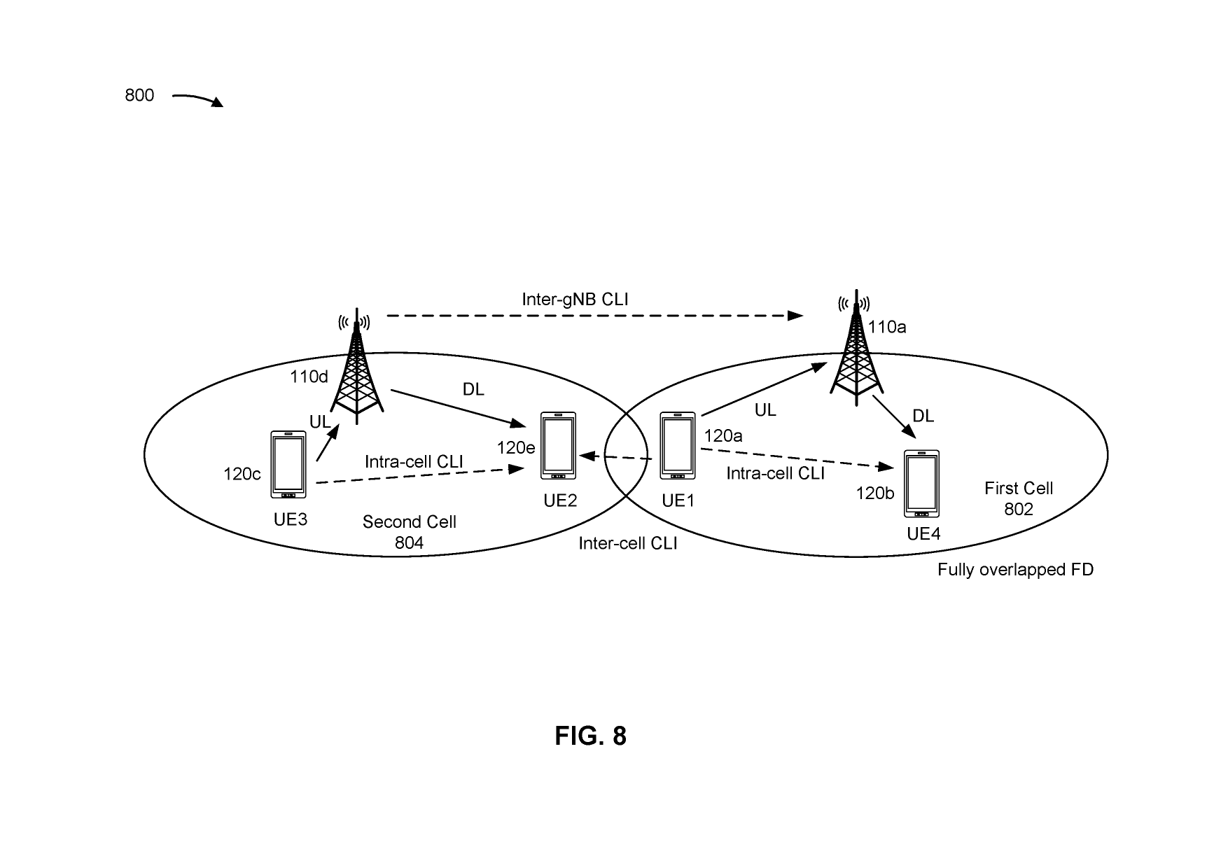

FIG. 8 is a diagram illustrating an example 800 of CLI, in accordance with the present disclosure.

As shown in FIG. 8, in a partially or fully overlapped FD scenario, a first network node 110a in a first cell 802 may receive an uplink transmission from a first UE 120a in the first cell 802. The first network node 110a may transmit a downlink transmission to a fourth UE 120b in the first cell 802. The first UE 120a may cause an intra-cell CLI to the fourth UE 120b based at least in part on the uplink transmission of the first UE 120a. A second network node 110d in a second cell 804 may receive an uplink transmission from a third UE 120c in the second cell 804. The second network node 110d may transmit a downlink transmission to a second UE 120e in the second cell 804. The third UE 120c may cause an intra-cell CLI to the second UE 120e based at least in part on the uplink transmission of the third UE 120c. Further, the first UE 120a in the first cell 702 may cause an inter-cell CLI to the second UE 120e in the second cell 804 based at least in part on the uplink transmission of the first UE 120a. Further, the first network node 110a may cause an in-band inter-gNB CLI to the second network node 110d, and vice versa.

As indicated above, FIG. 8 is provided as an example. Other examples may differ from what is described with regard to FIG. 8.

For inter-UE CLI, a layer 1 (L1) based UE-to-UE CLI measurement and reporting may be based at least in part on a CSI framework. The L1 based UE-to-UE CLI measurement and reporting may involve measurement resources. The measurement resources may include periodic, semi-persistent, or aperiodic measurement resources (or resource sets), e.g., SRS-RSRP resources or CLI-RSSI resources. The L1based UE-to-UE CLI measurement and reporting may involve measurement reporting, which may include aperiodic, periodic, or semi-persistent reporting. Report quantities may include L1-SRS-RSRP, L1-CLI-RSSI, and/or measurement resource indices. Wideband reporting may be supported. The measurement reporting may include UCI bits generation and priority rules for multiple CSI reporting.

For inter-gNB CLI, an inter-gNB CLI enhancement may involve an information exchange of a semi-static cell-specific SBFD time and frequency location configuration, an information exchange of a measurement resource configuration, e.g., synchronization signal block (SSB) and/or periodic non-zero-power (NZP) CSI-RS, an information exchange of strongest DL beam information, and/or an information exchange of a CLI-mitigation request. The inter-gNB CLIenhancement may involve an uplink resource muting for a PUSCH. An indication or determination of the uplink resource muting for the PUSCH may be based at least in part on a semi-static configuration, assuming comb-2 for both DFT-S-OFDM and CP-OFDM in each allocated physical resource block (PRB) and up to two symbols in a time domain. The uplink resource muting for the PUSCH may involve a PUSCH resource mapping, e.g., rate matching around muted resource elements (REs). For the uplink resource muting for the PUSCH, every other RE may be muted in a frequency domain, in accordance with a comb-2 pattern. The uplink resource muting for the PUSCH may involve a UCI resource determination in symbols with muted REs. The uplink resource muting for the PUSCH may not apply for a message A (Msg A) PUSCH and a message 3 (Msg 3) PUSCH. The uplink resource muting for the PUSCH may apply for UEs in an RRC connected mode. The uplink resource muting for the PUSCH may be associated with an uplink resource muting pattern. The uplink resource muting pattern may be assumed to not overlap an uplink DMRS or a phase tracking reference signal (PTRS) in a same symbol. Power boosting may be assumed for REs in a symbol with uplink resource muting. A PUSCH transmit power may not change across symbols. The uplink resource muting for the PUSCH may be subject to a UE capability.

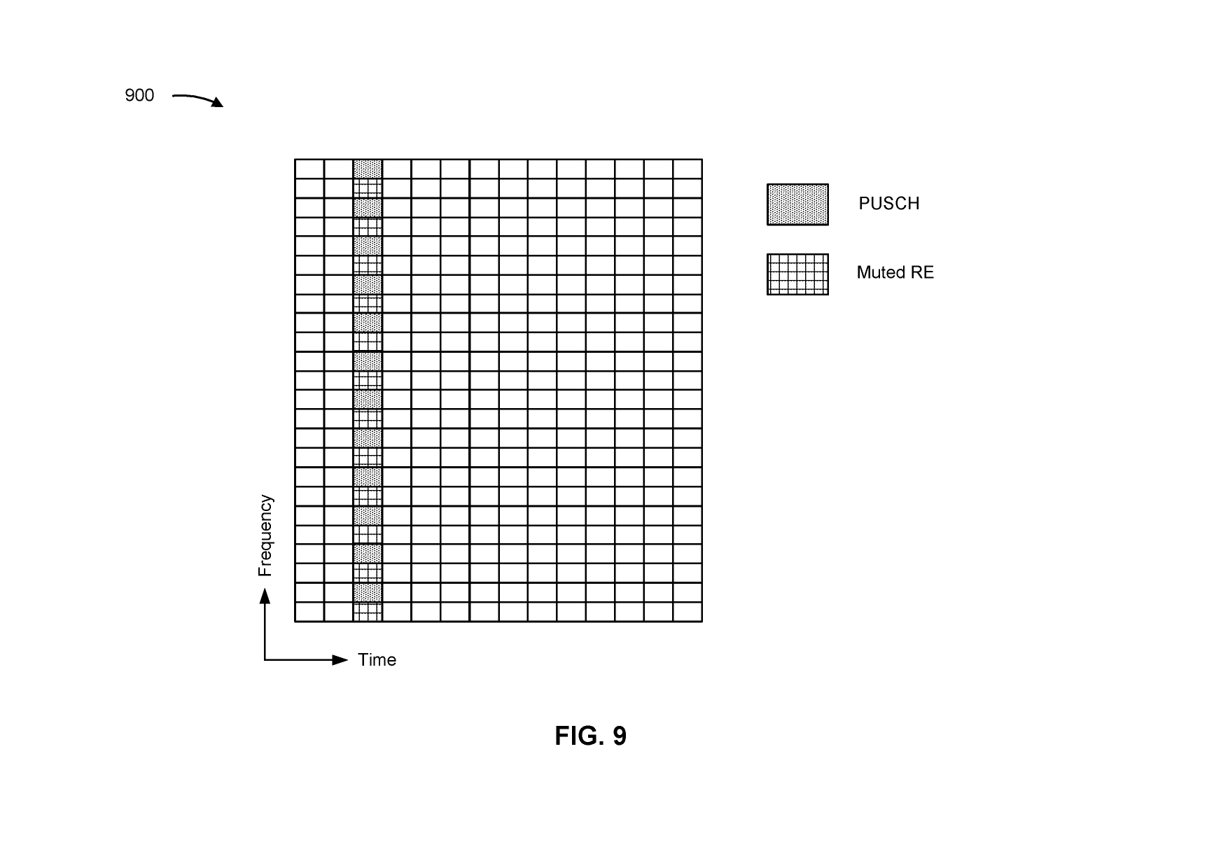

FIG. 9 is a diagram illustrating an example 900 of uplink resource muting, in accordance with the present disclosure.

As shown in FIG. 9, some resources may be associated with uplink transmissions, such as PUSCH transmissions. Other resources may be associated with uplink resource muting (e.g., every other RE in a frequency domain may be associated with uplink resource muting in accordance with an uplink resource muting pattern). During such resources, no uplink transmissions may be performed. Rather, these resources may be used for channel estimation from a downlink (e.g., from an aggressor gNB to a victim gNB). Thus, the resources associated with the uplink resource muting may be used for CLIhandling.

As indicated above, FIG. 9 is provided as an example. Other examples may differ from what is described with regard to FIG. 9.

One or more parameters may be configured for PUSCH transmissions on a BWP. Such parameters may include common parameters. For example, a maximum transmission rank may be configured by a maximum rank (maxRank) higher layer parameter in a PUSCH configuration (pusch-Config) for a PUSCH scheduled with DCI format 0_1 and a maximum rank (maxRankDCI-0-2) higher layer parameter for a PUSCH scheduled with DCI format 0_2. Other parameters may be used to indicate a set of choices, and a selection may be based at least in part on a scheduling DCI.

A PUSCH time domain resource allocation (TDRA) list (PUSCH-timeDomainResourceAllocationList) may contain one or more of such PUSCH time domain resource allocations (PUSCH-TimeDomainResourceAllocations). A network node may indicate, to a UE in an uplink grant, a configured TDRA to be applied by the UE for the uplink grant. The UE may determine a bit width of a DCI field based at least in part on a number of entries in the PUSCH time domain resource allocation list. A value of 0 in the DCI field may refer to a first element in the PUSCH TDRA list, a value 1 in the DCI field may refer to a second element in the PUSCH TDRA list, and so on. Further, the PUSCH TDRA list may indicate an offset (e.g., K2, which may be an integer value that indicates an offset between a downlink slot in which a PDCCH (e.g., DCI) for an uplink scheduling is received and an uplink slot in which uplink data is to be sent via a PUSCH), a mapping type (mappingType) (e.g., Type A or Type B) and a start symbol and length (startSymbolAndLength).

An applicable PUSCH TDRA for DCI format 0_1 in a UE specific search space may be given by a TDRA table in the PUSCH configuration. Otherwise, the applicable PUSCH TDRA may be given by a default PUSCH TDRA. The UE-specific search space may be scrambled with a cell radio network temporary identifier (RNTI) (C-RNTI), an MCS cell RNTI (MCS-C-RNTI), a configured scheduling (CS) RNTI (CS-RNTI), or a semi-persistent (SP) CSI RNTI (SP-CSI-RNTI). The TDRA table in the PUSCH configuration may be based at least in part on a PUSCH mapping type (e.g., Type A or Type B). In the TDRA table, a given row index may be associated with the PUSCH mapping type, the offset (K2), the start symbol (S), and the length (L).

The PUSCH configuration may be used to configure UE-specific PUSCH parameters, where the UE-specific PUSCH parameters may be applicable to a particular BWP. The PUSCH configuration may include a PUSCH time domain allocation list (pusch-TimeDomainAllocationList), which may indicate a list of time domain allocations for timing of uplink assignment to uplink data. The PUSCH configuration may include PUSCH time domain allocation lists that configure TDRA tables for DCI format 0_1 and/or DCI format 0_2.

A serving cell configuration (ServingCellConfig) may be used to conFIGURE(e.g., add or modify) the UE with a serving cell, which may be a special cell (SpCell), a primary cell (PCell), or a secondary cell (SCell) of a master cell group (MCG) or a secondary cell group (SCG). The serving cell configuration may indicate UE-specific parameters and/or cell-specific parameters.

A PUSCH resource mapping may be Type A or Type B. For a PUSCH resource mapping Type A, a DMRS may be configured at a fixed symbol location, e.g., symbol 3 of a slot. PUSCH data symbols may be mapped to a first symbol of the slot with a configured length. In other words, for the PUSCH resource mapping Type A, a DMRS location may be fixed to symbol 3, where a PUSCH starting symbol may always be a first symbol in a PUSCH. For a PUSCH resource mapping Type B, a DMRS may be front loaded to PUSCH data symbols, where a start symbol and a length of a PUSCH may be configurable. In other words, for the PUSCH resource mapping Type B, a DMRS location may be fixed to a first symbol of an allocated PUSCH, where a PUSCH starting symbol may be symbol 0 to symbol 13.

However, when uplink resource muting is configured for a PUSCH, the uplink resource muting may not consider the PUSCH resource mapping. The uplink resource muting may not consider the PUSCH resource mapping Type A and the PUSCH resource mapping Type B. A UE may be indicated with the uplink resource muting via a semi-static configuration, but the uplink resource muting may not be based at least in part on the PUSCH resource mapping. As a result, when the PUSCH resource mapping Type A or the PUSCH resource mapping Type A is used, a UE may not be properly configured to employ the uplink resource muting, thereby degrading an overall system performance.

In various aspects of techniques and apparatuses described herein, a UE may receive, from a network node, a configuration that indicates one or more uplink resource muting patterns based at least in part on a first PUSCH resource mapping type (e.g., Type A) or a second PUSCH resource mapping type (e.g., Type B). The one or more uplink resource muting patterns may be per PUSCH resource mapping type, where the PUSCH resource mapping type may include the first PUSCH resource mapping type or the second PUSCH resource mapping type. In some aspects, the configuration may indicate one uplink resource muting pattern for the first PUSCH resource mapping type and another uplink resource muting pattern for the second PUSCH resource mapping type. In some aspects, the configuration may indicate more than one uplink resource muting pattern for the first PUSCH resource mapping type and more than one uplink resource muting pattern for the second PUSCH resource mapping type. In some aspects, the configuration may indicate one uplink resource muting pattern for the first PUSCH resource mapping type and the second PUSCH resource mapping type. In some aspects, the configuration may indicate a plurality of uplink resource muting patterns that are common for the first PUSCH resource mapping type and the second PUSCH resource mapping type. As a result, the network node may configure uplink resource muting patterns based at least in part on PUSCH resource mapping types, thereby improving an overall system performance.

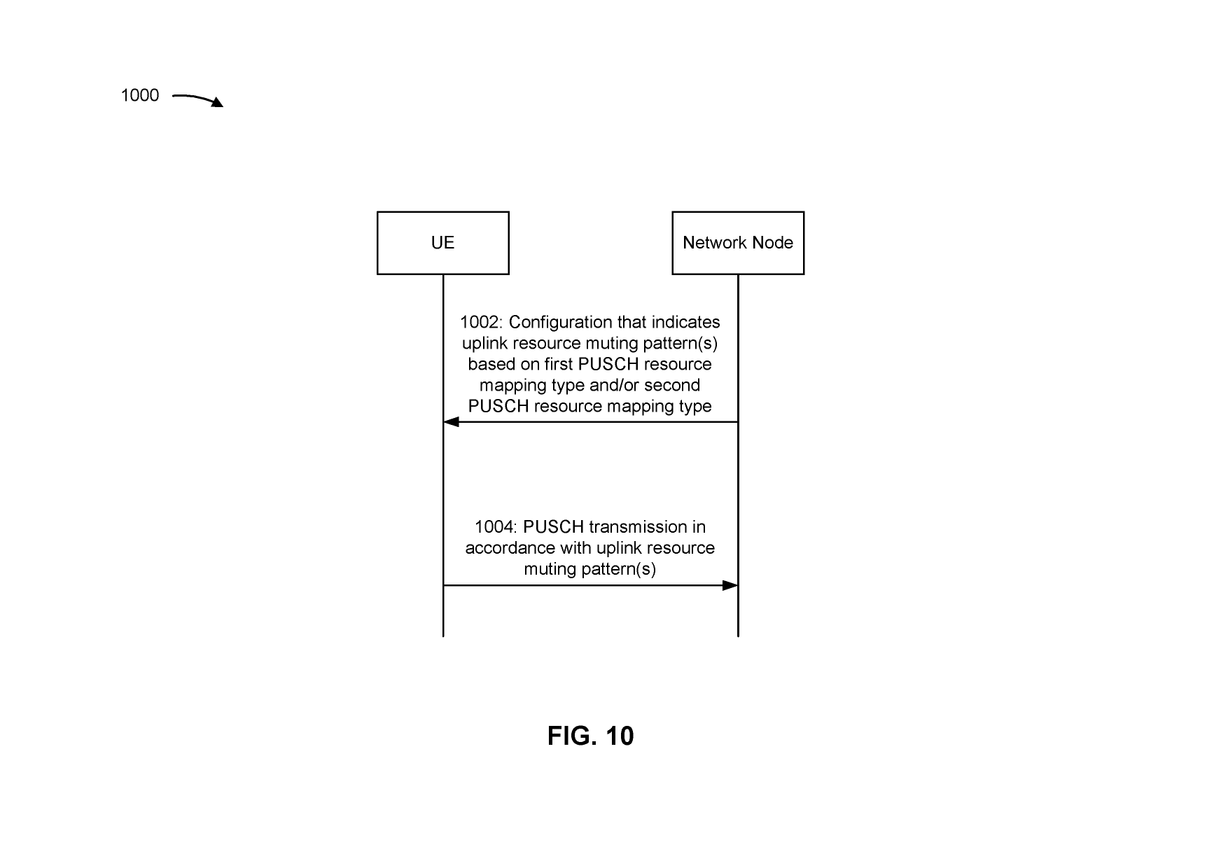

FIG. 10 is a diagram illustrating an example 1000 associated with configuring uplink resource muting patterns, in accordance with the present disclosure. As shown in FIG. 10, example 1000 includes communication between a UE (e.g., UE 120) and a network node (e.g., network node 110). In some aspects, the UE and the network node may be included in a wireless network, such as wireless network 100.

In shown by reference number 1002, the UE may receive, from the network node, a configuration that indicates one or more uplink resource muting patterns based at least in part on a first PUSCH resource mapping type and/or a second PUSCH resource mapping type. In some aspects, the one or more uplink resource muting patterns may be per PUSCH resource mapping type, where the PUSCH resource mapping type may include the first PUSCH resource mapping type or the second PUSCH resource mapping type. In some aspects, the UE may receive, from the network node, a serving cell configuration or an uplink BWP configuration that indicates the one or more uplink resource muting patterns. In some aspects, an uplink resource muting pattern, of the one or more uplink resource muting patterns, may be associated with a frequency domain pattern and a time domain pattern. The frequency domain pattern may be a comb-2 like pattern (e.g., every other RE in a frequency domain is associated with a muted resource), and a frequency location of the frequency domain pattern may be associated with a PUSCH frequency allocation. The time domain pattern may be different per PUSCH resource mapping type. In some aspects, a frequency location of an uplink resource muting may not be configured, or the frequency location may be configured with a starting PRB, an ending PRB, and/or a length.

In some aspects, the network node may configure one or more uplink resource muting patterns per PUSCH resource mapping type (e.g., per PUSCH resource mapping Type A and PUSCH resource mapping Type B). Different uplink resource muting patterns may be configured per PUSCH resource mapping type due to different PUSCH resource mapping for Type A and Type B. The uplink resource muting pattern may be configured under the serving cell configuration or under the uplink BWP configuration. The uplink resource muting pattern, for a frequency domain, may be a comb-2 like uplink resource muting pattern, where the frequency location may be associated with the PUSCH frequency allocation. The uplink resource muting pattern may be associated with a comb offset (combOffset) of (0,1) or a fixed comb offset, e.g., offset=0. The uplink resource muting pattern, for a time domain, may be different per each PUSCH resource mapping type. The frequency location of the uplink resource muting may not be configured (e.g., the frequency location may be the same as PUSCH allocated PRBs). The frequency location of the uplink resource muting may be configured with the starting PRB and the length, or the starting PRB and the ending PRB.

In some aspects, the configuration may indicate a first uplink resource muting pattern for the first PUSCH resource mapping type and a second uplink resource muting pattern for the second PUSCH resource mapping type. The first uplink resource muting pattern for the first PUSCH resource mapping type may be configured as one or two muted symbols per slot or per PUSCH. The second uplink resource muting pattern for the second PUSCH resource mapping type may be configured as one or two muted symbols per slot. In some aspects, the UE may receive, from the network node, a PUSCH configuration that includes a TDRA table. The TDRA table may indicate the first PUSCH resource mapping type and the second PUSCH resource mapping type. The UE may apply an uplink resource muting pattern, of the one or more uplink resource muting patterns, to a plurality of PUSCH transmissions with the first PUSCH resource mapping type or the second PUSCH resource mapping type, or to a subset of PUSCH transmissions with the first PUSCH resource mapping type or the second PUSCH resource mapping type. In some aspects, the UE may transmit, to the network node, UE capability signaling that indicates that one uplink resource muting pattern per PUSCH resource mapping type is supported by the UE. In some aspects, an uplink resource muting, associated with the one or more uplink resource muting patterns, may be associated with an uplink rate matching.

In some aspects, in a first case, the network node may configure one uplink resource muting pattern per PUSCH mapping type. The network node may configure one uplink resource muting pattern for PUSCH resource mapping type A and one uplink resource muting pattern for PUSCH resource mapping type B. For example, for the PUSCH resource mapping type A, the uplink resource muting pattern may be configured as one or two muted symbols per slot or per PUSCH, e.g., symbol #1 muted only, or symbol #1 and symbol #5 muted (one muted symbol before a DMRS symbol and one muted symbol after the DMRS symbol). As another example, for the PUSCH resource mapping type B, the uplink resource muting pattern may be configured as one or two muted symbols per slot, e.g., symbol #2 muted (one muted symbol after a front loaded DMRS symbol), or symbol #2 and #5 muted (two muted symbols after a front loaded DMRS symbol).

In some aspects, the UE may use an implicit rule to apply the uplink resource muting pattern to all PUSCH transmissions with an associated PUSCH resource mapping type or a subset of PUSCH transmissions with an associated PUSCH resource mapping type. For example, the UE may apply a first uplink resource muting pattern for PUSCH resource mapping Type A and a second uplink resource muting pattern for PUSCH resource mapping Type B. In some aspects, the PUSCH resource mapping Type A and the PUSCH resource mapping Type B may be indicated, by the network node, to the UE via a TDRA table of a PUSCH configuration. In other words, the network node may transmit, to the UE, the PUSCH configuration which indicates the PUSCH resource mapping Type A and the PUSCH resource mapping Type B. In some aspects, the UE may transmit, to the network node, the UE capability signaling to indicate that the UE supports one uplink resource muting pattern per PUSCH resource mapping type. Further, the uplink resource muting may be associated with the uplink rate matching.

In some aspects, the configuration may indicate more than one uplink resource muting pattern for the first PUSCH resource mapping type and more than one uplink resource muting pattern for the second PUSCH resource mapping type. The more than one uplink resource muting pattern for the first PUSCH resource mapping type may be configured as one muted symbol before a DMRS symbol and one muted symbol after the DMRS symbol. The more than one uplink resource muting pattern for the second PUSCH resource mapping type may be configured as two muted symbols after a front-loaded DMRS symbol. In some aspects, the UE may transmit, to the network node, UE capability signaling that indicates that more than one uplink resource muting pattern per PUSCH resource mapping type is supported by the UE. The UE capability signaling may indicate a number of uplink resource muting patterns that are supported per PUSCH resource mapping type. The UE capability signaling may indicate a number of muted symbols per pattern, per PUSCH, or per slot that are supported by the UE.

In some aspects, in a second case, the network node may configure more than one uplink resource muting pattern per PUSCH mapping type. The network node may configure two uplink resource muting patterns for PUSCH resource mapping type A and two uplink resource muting patterns for PUSCH resource mapping type B. As an example, for the PUSCH resource mapping Type A, two uplink resource muting patterns may be configured, e.g., Pattern 1 is symbol 1 muted only and Pattern 2 is symbol 1 and symbol 5 muted (one muted symbol before a DMRS symbol and one muted symbol after the DMRS symbol). As another example, for the PUSCH resource mapping Type A, two uplink resource muting patterns may be configured, e.g., Pattern 1 is symbol 1 and symbol 5 muted (one muted symbol before a DMRS symbol and one muted symbol after the DMRS symbol), and Pattern 2 is symbol 2 and symbol 6 muted (one muted symbol before a DMRS symbol and one muted symbol after the DMRS symbol). As an example, for the PUSCH resource mapping Type B, two uplink resource muting patterns may be configured, e.g., Pattern 1 is symbol 2 muted (one muted symbol after a front loaded DMRS symbol) and Pattern 2 is symbol 2 and 5 muted (two muted symbols after a front loaded DMRS symbol). As another example, for the PUSCH resource mapping Type B, two uplink resource muting patterns may be configured, e.g., Pattern 1 is symbol 2 and 5 muted (two muted symbols after a front loaded DMRS symbol), and Pattern 2 is symbol 3 and 7 muted (two muted symbols after a front loaded DMRS symbol).

In some aspects, the PUSCH resource mapping Type A and the PUSCH resource mapping Type B may be indicated, by the network node, to the UE via a TDRA table of a PUSCH configuration. In other words, the network node may transmit, to the UE, the PUSCH configuration which indicates the PUSCH resource mapping Type A and the PUSCH resource mapping Type B. In some aspects, the UE may transmit, to the network node, the UE capability signaling to indicate that the UE supports more than one uplink resource muting pattern per PUSCH resource mapping type. The UE capability signaling may indicate the number of uplink resource muting patterns that are supported by the UE per PUSCH resource mapping type. The UE capability signaling may indicate the number of muted symbols that the UE is capable of supporting per uplink resource muting pattern or per PUSCH or per slot.

In some aspects, the UE may determine which uplink resource muting pattern, of the more than one uplink resource muting pattern for the first PUSCH resource mapping type and the more than one uplink resource muting pattern for the second PUSCH resource mapping type, is to be applied to a PUSCH with an associated PUSCH resource mapping type based at least in part on: an implicit rule depending on a PUSCH symbol length, RRC signaling associated with a PUSCH configuration, or a TDRA table configuration. The TDRA table configuration may be associated with a column entry or an RRC configured entry. The column entry may indicate the uplink resource muting pattern. The RRC configured entry may indicate a pattern index associated with the uplink resource muting pattern.

In some aspects, in the second case, since more than one uplink resource muting pattern may be configured per PUSCH resource mapping type, the UE may be indicated which uplink resource muting pattern is to apply to a PUSCH with an associated PUSCH resource mapping type. In a first option, such an indication may be based at least in part on an implicit rule. For example, for a PUSCH resource mapping type, when a PUSCH length is less than K symbols, Pattern 1 of a pattern list associated with PUSCH resource mapping Type A or PUSCH resource mapping Type B may be applied. Otherwise, Pattern 2 of the pattern list associated with PUSCH resource mapping Type A or PUSCH resource mapping Type B may be applied. In a second option, the indication may be via RRC signaling, e.g., in a PUSCH configuration information element (IE). In a third option, the indication may be via a TDRA table configuration (e.g., via a new column entry or an RRC configured entry). The implicit rule, the RRC signaling, or the TDRA table configuration may be used to indicate which uplink resource muting pattern is to apply to the PUSCH with the associated PUSCH resource mapping type.

As an example, the new column entry may be associated with an uplink resource muting pattern. Each row index of the TDRA table configuration may be associated with a PUSCH mapping type (e.g., Type A or Type B), specific offset (K2), a start symbol (S), a length (L), and the uplink resource muting pattern. Different uplink resource muting patterns may be associated with different row indexes and different PUSCH mapping types. As another example, a PUSCH TDRA list may indicate the offset (K2), a mapping type (mappingType) (e.g., Type A or Type B), a start symbol and length (startSymbolAndLength), and a pattern index (PatternIndex) (e.g., the RRC configured entry). The pattern index may be an integer value that is associated with a certain uplink resource muting pattern.

In some aspects, the configuration may indicate one uplink resource muting pattern for the first PUSCH resource mapping type and the second PUSCH resource mapping type. The one uplink resource muting pattern may be configured as one or two muted symbols per slot or per PUSCH.

In some aspects, in a third case, the network node may configure one uplink resource muting pattern for both PUSCH resource mapping Types A and B. For example, for PUSCH resource mapping Type A and PUSCH resource mapping Type B, the uplink resource muting pattern may be configured as one or two muted symbols per slot or per PUSCH, e.g., symbol 1 muted only, or symbol 1 and symbol 5 muted for both PUSCH resource mapping Types A and B.

In some aspects, the configuration may indicate a plurality of uplink resource muting patterns that are common for the first PUSCH resource mapping type and the second PUSCH resource mapping type. The plurality of uplink resource muting patterns may be configured as a list of one or two muted symbols per slot or per PUSCH. The UE may determine which uplink resource muting pattern, of the plurality of uplink resource muting patterns, is to be applied to a PUSCH based at least in part on: an implicit rule depending on a PUSCH symbol length, RRC signaling associated with a PUSCH configuration, or a TDRA table configuration. The TDRA table configuration may be associated with a column entry or an RRC configured entry. The UE may transmit, to the network node, UE capability signaling that indicates that the plurality of uplink resource muting patterns are supported by the UE. The UE capability signaling may indicate a number of uplink resource muting patterns that are supported by the UE. The UE capability signaling may indicate a number of muted symbols per pattern, per PUSCH, or per slot that are supported by the UE.

In some aspects, in a fourth case, the network node may configure N uplink resource muting patterns that are common for both PUSCH resource mapping Types A and B, where N is an integer. For the PUSCH resource mapping Types A and B, the N uplink resource muting patterns may be configured using a list as one or two muted symbols per slot or per PUSCH, e.g., symbol 1 muted only, symbol 1 and symbol 5 muted, or symbol 2 and symbol 6 muted.

In some aspects, since more than one uplink resource muting pattern may be configured, the UE may be indicated which uplink resource muting pattern is to apply to a PUSCH. In a first option, such an indication may be based at least in part on an implicit rule. For example, for a PUSCH resource mapping type, when a PUSCH length is less than K symbols, Pattern 1 of a pattern list associated with PUSCH resource mapping Type A or PUSCH resource mapping Type B may be applied. Otherwise, Pattern 2 of the pattern list associated with PUSCH resource mapping Type A or PUSCH resource mapping Type B may be applied. In a second option, the indication may be via RRC signaling, e.g., in a PUSCH configuration IE. In a third option, the indication may be via a TDRA table configuration. For example, a new column entry in the TDRA table configuration may be used to indicate which uplink resource muting pattern is to apply to the PUSCH with the associated PUSCH resource mapping type. Alternatively, or additionally, the indication may be via an RRC configured entry (e.g., a new RRC field in a PUSCH TDRA list).

In some aspects, the UE may transmit, to the network node, the UE capability signaling to indicate that the UE supports more than one uplink resource muting pattern (e.g., the UE supports the N uplink resource muting patterns). The UE capability signaling may indicate the number of uplink resource muting patterns that are supported by the UE. The UE capability signaling may indicate the number of muted symbols that the UE is capable of supporting per uplink resource muting pattern or per PUSCH or per slot.

In some aspects, an uplink resource muting pattern, of the one or more uplink resource muting patterns, may be associated with a symbol index and a reference time location. The symbol index may be based at least in part on a bitmap or a symbol index number. The reference time location may be a first symbol of a slot, a first symbol of a PUSCH allocation, or a first DMRS of a PUSCH. The reference time location may be the same or different per PUSCH resource mapping type. In some aspects, the one or more uplink resource muting patterns may be excluded from being applied to certain uplink channels or reference signal types.

In some aspects, the symbol index may be based at least in part on the bitmap or the symbol index number. The reference time location may be referred to as the first symbol of the slot, the first symbol of the PUSCH allocation, or the first DMRS symbol of the PUSCH. The reference time location may be the same or different per PUSCH resource mapping type. When the reference time location is different per PUSCH resource mapping type, the PUSCH resource mapping Type A may be referenced to a first symbol of a slot, and the PUSCH resource mapping Type B may be referenced to a first symbol of a PUSCH or a front loaded DMRS. In some aspects, an application of the uplink resource muting may be associated with some restrictions. The uplink resource muting may not apply to certain uplink channels or resource types. For example, the uplink resource muting may not apply to PUSCH Type B or PUSCH repetition Type B.

As shown by reference number 1004, the UE may transmit, to the network node, a PUSCH transmission in accordance with the one or more uplink resource muting patterns. For example, the UE may transmit the PUSCH transmission using unmuted PUSCH REs, where muted REs may not be used for the PUSCH transmission. The unmuted PUSCH REs and the muted REs may be in accordance with the one or more uplink resource muting patterns. The network nose may use the muted REs for CLI handling (e.g., CLI measurements and/or CLI mitigation).

As indicated above, FIG. 10 is provided as an example. Other examples may differ from what is described with regard to FIG. 10.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with configuring uplink resource muting patterns.

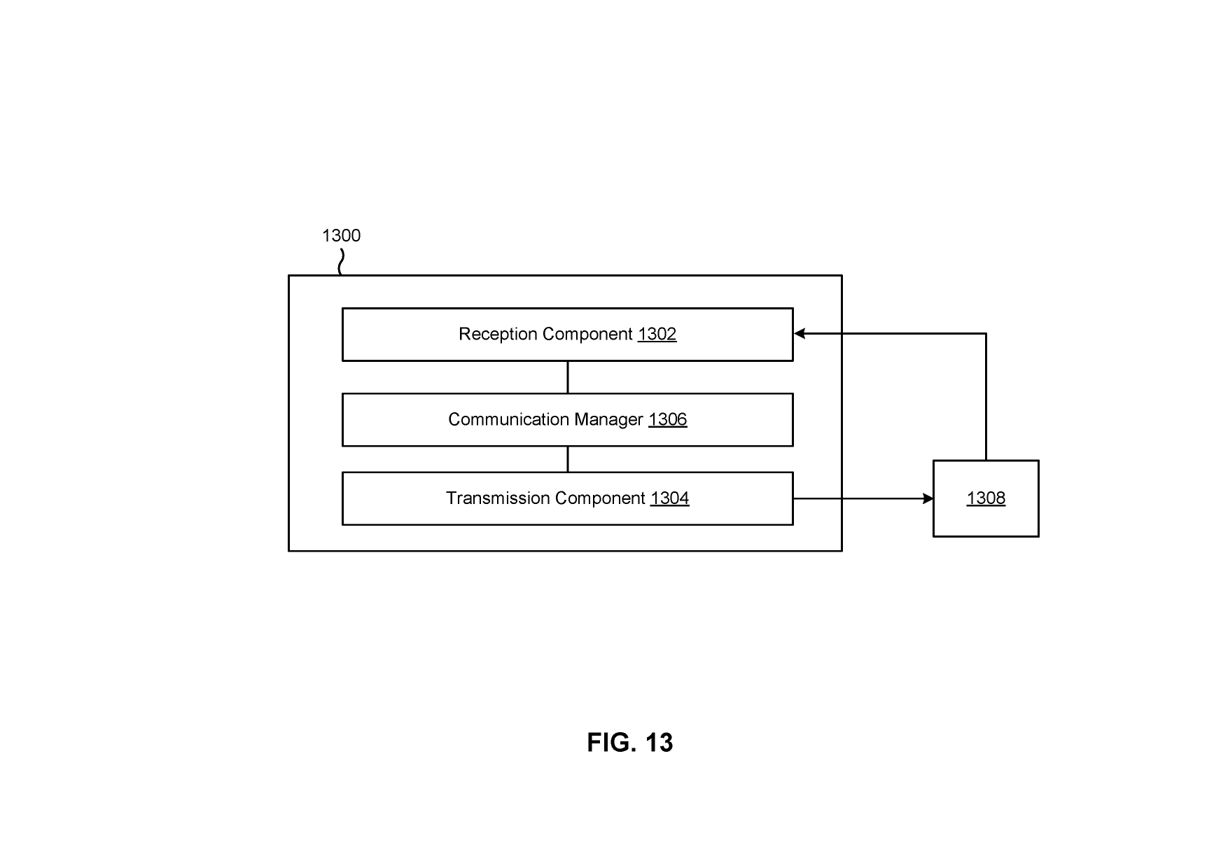

As shown in FIG. 11, in some aspects, process 1100 may include receiving a configuration that indicates one or more uplink resource muting patterns based at least in part on one or more of a first PUSCH resource mapping type or a second PUSCH resource mapping type (block 1110). For example, the UE (e.g., using reception component 1302 and/or communication manager 1306, depicted in FIG. 13) may receive a configuration that indicates one or more uplink resource muting patterns based at least in part on one or more of a first PUSCH resource mapping type or a second PUSCH resource mapping type, as described above.

As further shown in FIG. 11, in some aspects, process 1100 may include transmitting a PUSCH transmission in accordance with the one or more uplink resource muting patterns (block 1120). For example, the UE (e.g., using transmission component 1304 and/or communication manager 1306, depicted in FIG. 13) may transmit a PUSCH transmission in accordance with the one or more uplink resource muting patterns, as described above.

Process 1100 may include additional aspects, such as any single aspect or any combination of aspects described below and/or in connection with one or more other processes described elsewhere herein.

In a first aspect, the one or more uplink resource muting patterns are per PUSCH resource mapping type, and the PUSCH resource mapping type includes the first PUSCH resource mapping type or the second PUSCH resource mapping type.

In a second aspect, alone or in combination with the first aspect, process 1100 includes receiving a serving cell configuration or an uplink bandwidth part configuration that indicates the one or more uplink resource muting patterns.

In a third aspect, alone or in combination with one or more of the first and second aspects, an uplink resource muting pattern, of the one or more uplink resource muting patterns, is associated with a frequency domain pattern and a time domain pattern, wherein the frequency domain pattern is a comb-2 like pattern, wherein the time domain pattern is different per PUSCH resource mapping type, and wherein a frequency location of an uplink resource muting is not configured, or is configured with one or more of: a starting PRB, an ending PRB, or a length.

In a fourth aspect, alone or in combination with one or more of the first through third aspects, the configuration indicates a first uplink resource muting pattern for the first PUSCH resource mapping type and a second uplink resource muting pattern for the second PUSCH resource mapping type.

In a fifth aspect, alone or in combination with one or more of the first through fourth aspects, the first uplink resource muting pattern for the first PUSCH resource mapping type is configured as one or two muted symbols per slot or per PUSCH, or the second uplink resource muting pattern for the second PUSCH resource mapping type is configured as one or two muted symbols per slot.

In a sixth aspect, alone or in combination with one or more of the first through fifth aspects, process 1100 includes receiving a PUSCH configuration that includes a TDRA table, wherein the TDRA table indicates the first PUSCH resource mapping type and the second PUSCH resource mapping type, and applying an uplink resource muting pattern, of the one or more uplink resource muting patterns, to a plurality of PUSCH transmissions with the first PUSCH resource mapping type or the second PUSCH resource mapping type, or to a subset of PUSCH transmissions with the first PUSCH resource mapping type or the second PUSCH resource mapping type.

In a seventh aspect, alone or in combination with one or more of the first through sixth aspects, process 1100 includes transmitting UE capability signaling that indicates that one uplink resource muting pattern per PUSCH resource mapping type is supported by the UE.

In an eighth aspect, alone or in combination with one or more of the first through seventh aspects, an uplink resource muting, associated with the one or more uplink resource muting patterns, is associated with an uplink rate matching.

In a ninth aspect, alone or in combination with one or more of the first through eighth aspects, the configuration indicates more than one uplink resource muting pattern for the first PUSCH resource mapping type and more than one uplink resource muting pattern for the second PUSCH resource mapping type.

In a tenth aspect, alone or in combination with one or more of the first through ninth aspects, the more than one uplink resource muting pattern for the first PUSCH resource mapping type is configured as one muted symbol before a DMRS symbol and one muted symbol after the DMRS symbol, or the more than one uplink resource muting pattern for the second PUSCH resource mapping type is configured as two muted symbols after a front-loaded DMRS symbol.

In an eleventh aspect, alone or in combination with one or more of the first through tenth aspects, process 1100 includes transmitting UE capability signaling that indicates that more than one uplink resource muting pattern per PUSCH resource mapping type is supported by the UE, wherein the UE capability signaling indicates a number of uplink resource muting patterns that are supported per PUSCH resource mapping type, and the UE capability signaling indicates a number of muted symbols per pattern, per PUSCH, or per slot that are supported by the UE.

In a twelfth aspect, alone or in combination with one or more of the first through eleventh aspects, process 1100 includes determining which uplink resource muting pattern, of the more than one uplink resource muting pattern for the first PUSCH resource mapping type and the more than one uplink resource muting pattern for the second PUSCH resource mapping type, is to be applied to a PUSCH with an associated PUSCH resource mapping type based at least in part on an implicit rule depending on a PUSCH symbol length, RRC signaling associated with a PUSCH configuration, or a TDRA table configuration.

In a thirteenth aspect, alone or in combination with one or more of the first through twelfth aspects, the TDRA table configuration is associated with a column entry or an RRC configured entry, wherein the column entry indicates the uplink resource muting pattern, and the RRC configured entry indicates a pattern index associated with the uplink resource muting pattern.

In a fourteenth aspect, alone or in combination with one or more of the first through thirteenth aspects, the configuration indicates one uplink resource muting pattern for the first PUSCH resource mapping type and the second PUSCH resource mapping type, and wherein the one uplink resource muting pattern is configured as one or two muted symbols per slot or per PUSCH.

In a fifteenth aspect, alone or in combination with one or more of the first through fourteenth aspects, the configuration indicates a plurality of uplink resource muting patterns that are common for the first PUSCH resource mapping type and the second PUSCH resource mapping type, and the plurality of uplink resource muting patterns are configured as a list of one or two muted symbols per slot or per PUSCH.

In a sixteenth aspect, alone or in combination with one or more of the first through fifteenth aspects, process 1100 includes determining which uplink resource muting pattern, of the plurality of uplink resource muting patterns, is to be applied to a PUSCH based at least in part on an implicit rule depending on a PUSCH symbol length, RRC signaling associated with a PUSCH configuration, or a TDRA table configuration, wherein the TDRA table configuration is associated with a column entry or an RRC configured entry.

In a seventeenth aspect, alone or in combination with one or more of the first through sixteenth aspects, process 1100 includes transmitting UE capability signaling that indicates that the plurality of uplink resource muting patterns are supported by the UE, wherein the UE capability signaling indicates a number of uplink resource muting patterns that are supported by the UE, and the UE capability signaling indicates a number of muted symbols per pattern, per PUSCH, or per slot that are supported by the UE.

In an eighteenth aspect, alone or in combination with one or more of the first through seventeenth aspects, an uplink resource muting pattern, of the one or more uplink resource muting patterns, is associated with a symbol index and a reference time location, wherein the symbol index is based at least in part on a bitmap or a symbol index number, wherein the reference time location is a first symbol of a slot, a first symbol of a PUSCH allocation, or a first DMRS of a PUSCH, and the reference time location is same or different per PUSCH resource mapping type.

In a nineteenth aspect, alone or in combination with one or more of the first through eighteenth aspects, the one or more uplink resource muting patterns are excluded from being applied to certain uplink channels or reference signal types.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with configuring uplink resource muting patterns.

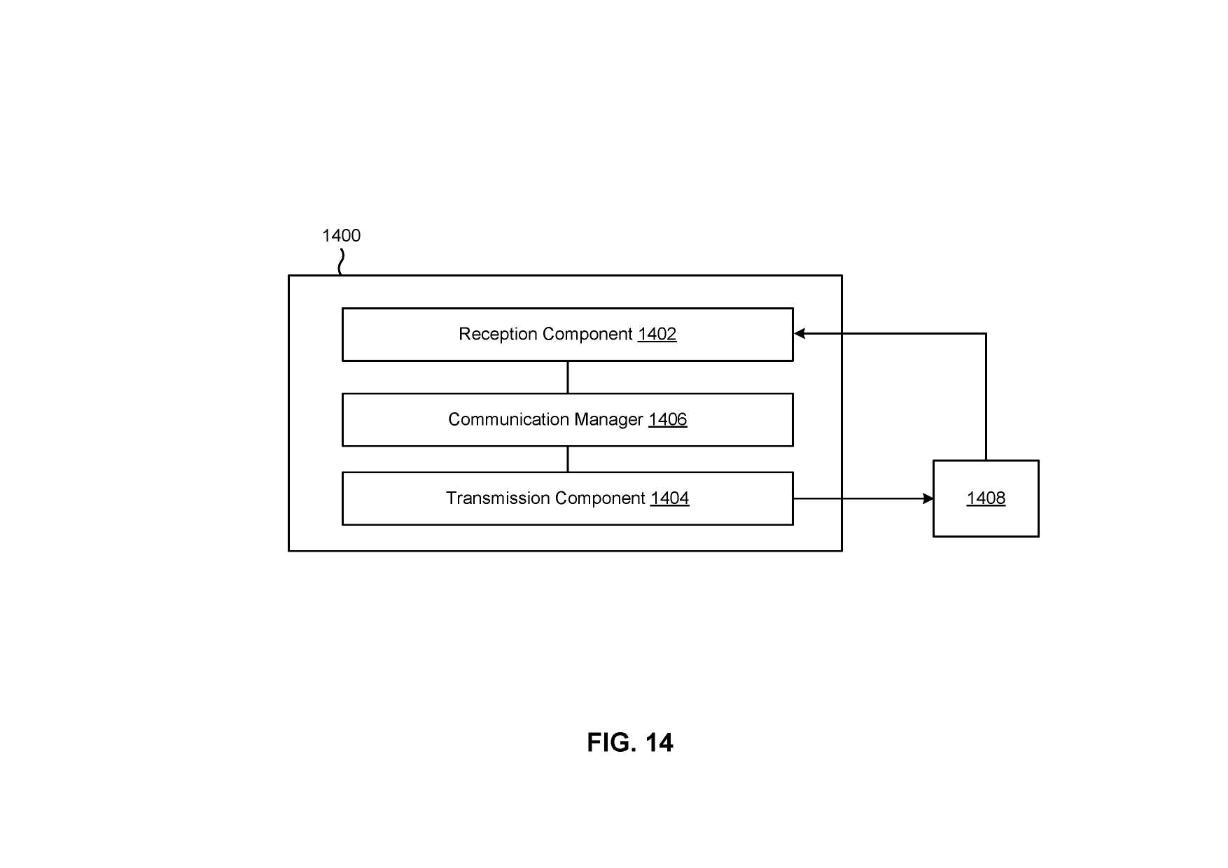

As shown in FIG. 12, in some aspects, process 1200 may include transmitting a configuration that indicates one or more uplink resource muting patterns based at least in part on one or more of a first PUSCH resource mapping type or a second PUSCH resource mapping type (block 1210). For example, the network node (e.g., using transmission component 1404 and/or communication manager 1406, depicted in FIG. 14) may transmit a configuration that indicates one or more uplink resource muting patterns based at least in part on one or more of a first PUSCH resource mapping type or a second PUSCH resource mapping type, as described above.

As further shown in FIG. 12, in some aspects, process 1200 may include receiving a PUSCH transmission in accordance with the one or more uplink resource muting patterns (block 1220). For example, the network node (e.g., using reception component 1402 and/or communication manager 1406, depicted in FIG. 14) may receive a PUSCH transmission in accordance with the one or more uplink resource muting patterns, as described above.

Process 1200 may include additional aspects, such as any single aspect or any combination of aspects described below and/or in connection with one or more other processes described elsewhere herein.

In a first aspect, the one or more uplink resource muting patterns are per PUSCH resource mapping type, and the PUSCH resource mapping type includes the first PUSCH resource mapping type or the second PUSCH resource mapping type.

In a second aspect, alone or in combination with the first aspect, process 1200 includes transmitting a serving cell configuration or an uplink bandwidth part configuration that indicates the one or more uplink resource muting patterns.

In a third aspect, alone or in combination with one or more of the first and second aspects, an uplink resource muting pattern, of the one or more uplink resource muting patterns, is associated with a frequency domain pattern and a time domain pattern, wherein the frequency domain pattern is a comb-2 like pattern, wherein the time domain pattern is different per PUSCH resource mapping type, and wherein a frequency location of an uplink resource muting is not configured, or is configured with one or more of: a starting PRB, an ending PRB, or a length.

In a fourth aspect, alone or in combination with one or more of the first through third aspects, the configuration indicates a first uplink resource muting pattern for the first PUSCH resource mapping type and a second uplink resource muting pattern for the second PUSCH resource mapping type.

In a fifth aspect, alone or in combination with one or more of the first through fourth aspects, the first uplink resource muting pattern for the first PUSCH resource mapping type is configured as one or two muted symbols per slot or per PUSCH, or the second uplink resource muting pattern for the second PUSCH resource mapping type is configured as one or two muted symbols per slot.

In a sixth aspect, alone or in combination with one or more of the first through fifth aspects, process 1200 includes transmitting a PUSCH configuration that includes a TDRA table, wherein the TDRA table indicates the first PUSCH resource mapping type and the second PUSCH resource mapping type, wherein an uplink resource muting pattern, of the one or more uplink resource muting patterns, is applied to a plurality of PUSCH transmissions with the first PUSCH resource mapping type or the second PUSCH resource mapping type, or to a subset of PUSCH transmissions with the first PUSCH resource mapping type or the second PUSCH resource mapping type.

In a seventh aspect, alone or in combination with one or more of the first through sixth aspects, process 1200 includes receiving a UE capability signaling that indicates that one uplink resource muting pattern per PUSCH resource mapping type is supported by a UE.

In an eighth aspect, alone or in combination with one or more of the first through seventh aspects, an uplink resource muting, associated with the one or more uplink resource muting patterns, is associated with an uplink rate matching.

In a ninth aspect, alone or in combination with one or more of the first through eighth aspects, the configuration indicates more than one uplink resource muting pattern for the first PUSCH resource mapping type and more than one uplink resource muting pattern for the second PUSCH resource mapping type.

In a tenth aspect, alone or in combination with one or more of the first through ninth aspects, the more than one uplink resource muting pattern for the first PUSCH resource mapping type is configured as one muted symbol before a DMRS symbol and one muted symbol after the DMRS symbol, or the more than one uplink resource muting pattern for the second PUSCH resource mapping type is configured as two muted symbols after a front-loaded DMRS symbol.

In an eleventh aspect, alone or in combination with one or more of the first through tenth aspects, process 1200 includes receiving a UE capability signaling that indicates that more than one uplink resource muting pattern per PUSCH resource mapping type is supported by a UE, wherein the UE capability signaling indicates a number of uplink resource muting patterns that are supported per PUSCH resource mapping type, and the UE capability signaling indicates a number of muted symbols per pattern, per PUSCH, or per slot that are supported by the UE.

In a twelfth aspect, alone or in combination with one or more of the first through eleventh aspects, the configuration indicates one uplink resource muting pattern for the first PUSCH resource mapping type and the second PUSCH resource mapping type, and wherein the one uplink resource muting pattern is configured as one or two muted symbols per slot or per PUSCH.

In a thirteenth aspect, alone or in combination with one or more of the first through twelfth aspects, the configuration indicates a plurality of uplink resource muting patterns that are common for the first PUSCH resource mapping type and the second PUSCH resource mapping type, and the plurality of uplink resource muting patterns are configured as a list of one or two muted symbols per slot or per PUSCH.

In a fourteenth aspect, alone or in combination with one or more of the first through thirteenth aspects, process 1200 includes receiving a UE capability signaling that indicates that the plurality of uplink resource muting patterns are supported by a UE, wherein the UE capability signaling indicates a number of uplink resource muting patterns that are supported by the UE, and the UE capability signaling indicates a number of muted symbols per pattern, per PUSCH, or per slot that are supported by the UE.

In a fifteenth aspect, alone or in combination with one or more of the first through fourteenth aspects, an uplink resource muting pattern, of the one or more uplink resource muting patterns, is associated with a symbol index and a reference time location, wherein the symbol index is based at least in part on a bitmap or a symbol index number, wherein the reference time location is a first symbol of a slot, a first symbol of a PUSCH allocation, or a first DMRS of a PUSCH, and the reference time location is same or different per PUSCH resource mapping type.

In a sixteenth aspect, alone or in combination with one or more of the first through fifteenth aspects, the one or more uplink resource muting patterns are excluded from being applied to certain uplink channels or reference signal types.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIG. 10. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the UE described in connection with FIG. 1 and FIG. 2. Additionally, or alternatively, one or more components shown in FIG. 13 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a configuration that indicates one or more uplink resource muting patterns based at least in part on one or more of a first PUSCH resource mapping type or a second PUSCH resource mapping type. The transmission component 1304 may transmit a PUSCH transmission in accordance with the one or more uplink resource muting patterns.

The reception component 1302 may receive a PUSCH configuration that includes a TDRA table, wherein the TDRA table indicates the first PUSCH resource mapping type and the second PUSCH resource mapping type. The communication manager 1306 may apply an uplink resource muting pattern, of the one or more uplink resource muting patterns, to a plurality of PUSCH transmissions with the first PUSCH resource mapping type or the second PUSCH resource mapping type, or to a subset of PUSCH transmissions with the first PUSCH resource mapping type or the second PUSCH resource mapping type. The transmission component 1304 may transmit UE capability signaling that indicates that one uplink resource muting pattern per PUSCH resource mapping type is supported by the UE. The transmission component 1304 may transmit UE capability signaling that indicates that more than one uplink resource muting pattern per PUSCH resource mapping type is supported by the UE, wherein the UE capability signaling indicates a number of uplink resource muting patterns that are supported per PUSCH resource mapping type, and wherein the UE capability signaling indicates a number of muted symbols per pattern, per PUSCH, or per slot that are supported by the UE.

The communication manager 1306 may determine which uplink resource muting pattern, of the more than one uplink resource muting pattern for the first PUSCH resource mapping type and the more than one uplink resource muting pattern for the second PUSCH resource mapping type, is to be applied to a PUSCH with an associated PUSCH resource mapping type based at least in part on: an implicit rule depending on a PUSCH symbol length, RRC signaling associated with a PUSCH configuration, or a TDRA table configuration. The communication manager 1306 may determine which uplink resource muting pattern, of the plurality of uplink resource muting patterns, is to be applied to a PUSCH based at least in part on: an implicit rule depending on a PUSCH symbol length, RRC signaling associated with a PUSCH configuration, or a TDRA table configuration, wherein the TDRA table configuration is associated with a column entry or an RRC configured entry. The transmission component 1304 may transmit UE capability signaling that indicates that the plurality of uplink resource muting patterns are supported by the UE, wherein the UE capability signaling indicates a number of uplink resource muting patterns that are supported by the UE, and wherein the UE capability signaling indicates a number of muted symbols per pattern, per PUSCH, or per slot that are supported by the UE.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIG. 10. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the network node described in connection with FIG. 1 and FIG. 2. Additionally, or alternatively, one or more components shown in FIG. 14 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit a configuration that indicates one or more uplink resource muting patterns based at least in part on one or more of a first PUSCH resource mapping type or a second PUSCH resource mapping type. The reception component 1402 may receive a PUSCH transmission in accordance with the one or more uplink resource muting patterns.

The transmission component 1404 may transmit a PUSCH configuration that includes a TDRA table, wherein the TDRA table indicates the first PUSCH resource mapping type and the second PUSCH resource mapping type, wherein an uplink resource muting pattern, of the one or more uplink resource muting patterns, is applied to a plurality of PUSCH transmissions with the first PUSCH resource mapping type or the second PUSCH resource mapping type, or to a subset of PUSCH transmissions with the first PUSCH resource mapping type or the second PUSCH resource mapping type. The reception component 1402 may receive a UE capability signaling that indicates that one uplink resource muting pattern per PUSCH resource mapping type is supported by a UE.

The reception component 1402 may receive a UE capability signaling that indicates that more than one uplink resource muting pattern per PUSCH resource mapping type is supported by a UE, wherein the UE capability signaling indicates a number of uplink resource muting patterns that are supported per PUSCH resource mapping type, and wherein the UE capability signaling indicates a number of muted symbols per pattern, per PUSCH, or per slot that are supported by the UE. The reception component 1402 may receive a UE capability signaling that indicates that the plurality of uplink resource muting patterns are supported by a UE, wherein the UE capability signaling indicates a number of uplink resource muting patterns that are supported by the UE, and wherein the UE capability signaling indicates a number of muted symbols per pattern, per PUSCH, or per slot that are supported by the UE.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving a configuration that indicates one or more uplink resource muting patterns based at least in part on one or more of a first physical uplink shared channel (PUSCH) resource mapping type or a second PUSCH resource mapping type; and transmitting a PUSCH transmission in accordance with the one or more uplink resource muting patterns.

Aspect 2: The method of Aspect 1, wherein the one or more uplink resource muting patterns are per PUSCH resource mapping type, and wherein the PUSCH resource mapping type includes the first PUSCH resource mapping type or the second PUSCH resource mapping type.

Aspect 3: The method of any of Aspects 1-2, wherein receiving the configuration comprises receiving a serving cell configuration or an uplink bandwidth part configuration that indicates the one or more uplink resource muting patterns.

Aspect 4: The method of any of Aspects 1-3, wherein an uplink resource muting pattern, of the one or more uplink resource muting patterns, is associated with a frequency domain pattern and a time domain pattern, wherein the frequency domain pattern is a comb-2 like pattern, wherein the time domain pattern is different per PUSCH resource mapping type, and wherein a frequency location of an uplink resource muting is not configured, or is configured with one or more of: a starting physical resource block (PRB), an ending PRB, or a length.

Aspect 5: The method of any of Aspects 1-4, wherein the configuration indicates a first uplink resource muting pattern for the first PUSCH resource mapping type and a second uplink resource muting pattern for the second PUSCH resource mapping type.

Aspect 6: The method of Aspect 5, wherein: the first uplink resource muting pattern for the first PUSCH resource mapping type is configured as one or two muted symbols per slot or per PUSCH; or the second uplink resource muting pattern for the second PUSCH resource mapping type is configured as one or two muted symbols per slot.

Aspect 7: The method of any of Aspects 1-6, further comprising: receiving a PUSCH configuration that includes a time domain resource allocation (TDRA) table, wherein the TDRA table indicates the first PUSCH resource mapping type and the second PUSCH resource mapping type; and applying an uplink resource muting pattern, of the one or more uplink resource muting patterns, to a plurality of PUSCH transmissions with the first PUSCH resource mapping type or the second PUSCH resource mapping type, or to a subset of PUSCH transmissions with the first PUSCH resource mapping type or the second PUSCH resource mapping type.

Aspect 8: The method of any of Aspects 1-7, further comprising: transmitting UE capability signaling that indicates that one uplink resource muting pattern per PUSCH resource mapping type is supported by the UE.

Aspect 9: The method of any of Aspects 1-8, wherein an uplink resource muting, associated with the one or more uplink resource muting patterns, is associated with an uplink rate matching.

Aspect 10: The method of any of Aspects 1-9, wherein the configuration indicates more than one uplink resource muting pattern for the first PUSCH resource mapping type and more than one uplink resource muting pattern for the second PUSCH resource mapping type.

Aspect 11: The method of Aspect 10, wherein: the more than one uplink resource muting pattern for the first PUSCH resource mapping type is configured as one muted symbol before a demodulation reference signal (DMRS) symbol and one muted symbol after the DMRS symbol; or the more than one uplink resource muting pattern for the second PUSCH resource mapping type is configured as two muted symbols after a front-loaded DMRS symbol.

Aspect 12: The method of Aspect 10, further comprising: transmitting UE capability signaling that indicates that more than one uplink resource muting pattern per PUSCH resource mapping type is supported by the UE, wherein the UE capability signaling indicates a number of uplink resource muting patterns that are supported per PUSCH resource mapping type, and wherein the UE capability signaling indicates a number of muted symbols per pattern, per PUSCH, or per slot that are supported by the UE.

Aspect 13: The method of Aspect 10, further comprising: determining which uplink resource muting pattern, of the more than one uplink resource muting pattern for the first PUSCH resource mapping type and the more than one uplink resource muting pattern for the second PUSCH resource mapping type, is to be applied to a PUSCH with an associated PUSCH resource mapping type based at least in part on: an implicit rule depending on a PUSCH symbol length, radio resource control (RRC) signaling associated with a PUSCH configuration, or a time domain resource allocation (TDRA) table configuration.

Aspect 14: The method of Aspect 13, wherein the TDRA table configuration is associated with a column entry or an RRC configured entry, wherein the column entry indicates the uplink resource muting pattern, and wherein the RRC configured entry indicates a pattern index associated with the uplink resource muting pattern.

Aspect 15: The method of any of Aspects 1-14, wherein the configuration indicates one uplink resource muting pattern for the first PUSCH resource mapping type and the second PUSCH resource mapping type, and wherein the one uplink resource muting pattern is configured as one or two muted symbols per slot or per PUSCH.

Aspect 16: The method of any of Aspects 1-15, wherein the configuration indicates a plurality of uplink resource muting patterns that are common for the first PUSCH resource mapping type and the second PUSCH resource mapping type, and wherein the plurality of uplink resource muting patterns are configured as a list of one or two muted symbols per slot or per PUSCH.

Aspect 17: The method of Aspect 16, further comprising: determining which uplink resource muting pattern, of the plurality of uplink resource muting patterns, is to be applied to a PUSCH based at least in part on: an implicit rule depending on a PUSCH symbol length, radio resource control (RRC) signaling associated with a PUSCH configuration, or a time domain resource allocation (TDRA) table configuration, wherein the TDRA table configuration is associated with a column entry or an RRC configured entry.

Aspect 18: The method of Aspect 16, further comprising: transmitting UE capability signaling that indicates that the plurality of uplink resource muting patterns are supported by the UE, wherein the UE capability signaling indicates a number of uplink resource muting patterns that are supported by the UE, and wherein the UE capability signaling indicates a number of muted symbols per pattern, per PUSCH, or per slot that are supported by the UE.

Aspect 19: The method of any of Aspects 1-18, wherein an uplink resource muting pattern, of the one or more uplink resource muting patterns, is associated with a symbol index and a reference time location, wherein the symbol index is based at least in part on a bitmap or a symbol index number, wherein the reference time location is a first symbol of a slot, a first symbol of a PUSCH allocation, or a first demodulation reference signal (DMRS) of a PUSCH, and wherein the reference time location is same or different per PUSCH resource mapping type.

Aspect 20: The method of any of Aspects 1-19, wherein the one or more uplink resource muting patterns are excluded from being applied to certain uplink channels or reference signal types.

Aspect 21: A method of wireless communication performed by a network node, comprising: transmitting a configuration that indicates one or more uplink resource muting patterns based at least in part on one or more of a first physical uplink shared channel (PUSCH) resource mapping type or a second PUSCH resource mapping type; and receiving a PUSCH transmission in accordance with the one or more uplink resource muting patterns.

Aspect 22: The method of Aspect 21, wherein the one or more uplink resource muting patterns are per PUSCH resource mapping type, and wherein the PUSCH resource mapping type includes the first PUSCH resource mapping type or the second PUSCH resource mapping type.

Aspect 23: The method of any of Aspects 21-22, wherein transmitting the configuration comprises transmitting a serving cell configuration or an uplink bandwidth part configuration that indicates the one or more uplink resource muting patterns.

Aspect 24: The method of any of Aspects 21-23, wherein an uplink resource muting pattern, of the one or more uplink resource muting patterns, is associated with a frequency domain pattern and a time domain pattern, wherein the frequency domain pattern is a comb-2 like pattern, wherein the time domain pattern is different per PUSCH resource mapping type, and wherein a frequency location of an uplink resource muting is not configured, or is configured with one or more of: a starting physical resource block (PRB), an ending PRB, or a length.

Aspect 25: The method of any of Aspects 21-24, wherein the configuration indicates a first uplink resource muting pattern for the first PUSCH resource mapping type and a second uplink resource muting pattern for the second PUSCH resource mapping type.

Aspect 26: The method of Aspect 25, wherein: the first uplink resource muting pattern for the first PUSCH resource mapping type is configured as one or two muted symbols per slot or per PUSCH; or the second uplink resource muting pattern for the second PUSCH resource mapping type is configured as one or two muted symbols per slot.

Aspect 27: The method of any of Aspects 21-26, further comprising: transmitting a PUSCH configuration that includes a time domain resource allocation (TDRA) table, wherein the TDRA table indicates the first PUSCH resource mapping type and the second PUSCH resource mapping type, wherein: an uplink resource muting pattern, of the one or more uplink resource muting patterns, is applied to a plurality of PUSCH transmissions with the first PUSCH resource mapping type or the second PUSCH resource mapping type, or to a subset of PUSCH transmissions with the first PUSCH resource mapping type or the second PUSCH resource mapping type.

Aspect 28: The method of any of Aspects 21-27, further comprising: receiving a user equipment (UE) capability signaling that indicates that one uplink resource muting pattern per PUSCH resource mapping type is supported by a UE.

Aspect 29: The method of any of Aspects 21-28, wherein an uplink resource muting, associated with the one or more uplink resource muting patterns, is associated with an uplink rate matching.

Aspect 30: The method of any of Aspects 21-29, wherein the configuration indicates more than one uplink resource muting pattern for the first PUSCH resource mapping type and more than one uplink resource muting pattern for the second PUSCH resource mapping type.

Aspect 31: The method of Aspect 30, wherein: the more than one uplink resource muting pattern for the first PUSCH resource mapping type is configured as one muted symbol before a demodulation reference signal (DMRS) symbol and one muted symbol after the DMRS symbol; or the more than one uplink resource muting pattern for the second PUSCH resource mapping type is configured as two muted symbols after a front-loaded DMRS symbol.

Aspect 32: The method of Aspect 30, further comprising: receiving a user equipment (UE) capability signaling that indicates that more than one uplink resource muting pattern per PUSCH resource mapping type is supported by a UE, wherein the UE capability signaling indicates a number of uplink resource muting patterns that are supported per PUSCH resource mapping type, and wherein the UE capability signaling indicates a number of muted symbols per pattern, per PUSCH, or per slot that are supported by the UE.

Aspect 33: The method of any of Aspects 21-32, wherein the configuration indicates one uplink resource muting pattern for the first PUSCH resource mapping type and the second PUSCH resource mapping type, and wherein the one uplink resource muting pattern is configured as one or two muted symbols per slot or per PUSCH.

Aspect 34: The method of any of Aspects 21-33, wherein the configuration indicates a plurality of uplink resource muting patterns that are common for the first PUSCH resource mapping type and the second PUSCH resource mapping type, and wherein the plurality of uplink resource muting patterns are configured as a list of one or two muted symbols per slot or per PUSCH.

Aspect 35: The method of Aspect 34, further comprising: receiving a user equipment (UE) capability signaling that indicates that the plurality of uplink resource muting patterns are supported by a UE, wherein the UE capability signaling indicates a number of uplink resource muting patterns that are supported by the UE, and wherein the UE capability signaling indicates a number of muted symbols per pattern, per PUSCH, or per slot that are supported by the UE.

Aspect 36: The method of any of Aspects 21-35, wherein an uplink resource muting pattern, of the one or more uplink resource muting patterns, is associated with a symbol index and a reference time location, wherein the symbol index is based at least in part on a bitmap or a symbol index number, wherein the reference time location is a first symbol of a slot, a first symbol of a PUSCH allocation, or a first demodulation reference signal (DMRS) of a PUSCH, and wherein the reference time location is same or different per PUSCH resource mapping type.

Aspect 37: The method of any of Aspects 21-36, wherein the one or more uplink resource muting patterns are excluded from being applied to certain uplink channels or reference signal types.

Aspect 38: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 39: An apparatus for wireless communication at a device, the apparatus comprising one or more memories and one or more processors coupled to the one or more memories, the one or more processors configured to cause the device to perform the method of one or more of Aspects 1-20.

Aspect 40: An apparatus for wireless communication, the apparatus comprising at least one means for performing the method of one or more of Aspects 1-20.

Aspect 41: A non-transitory computer-readable medium storing code for wireless communication, the code comprising instructions executable by one or more processors to perform the method of one or more of Aspects 1-20.

Aspect 42: A non-transitory computer-readable medium storing a set of instructions for wireless communication, the set of instructions comprising one or more instructions that, when executed by one or more processors of a device, cause the device to perform the method of one or more of Aspects 1-20.

Aspect 43: A device for wireless communication, the device comprising a processing system that includes one or more processors and one or more memories coupled with the one or more processors, the processing system configured to cause the device to perform the method of one or more of Aspects 1-20.

Aspect 44: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 45: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 21-37.

Aspect 46: An apparatus for wireless communication at a device, the apparatus comprising one or more memories and one or more processors coupled to the one or more memories, the one or more processors configured to cause the device to perform the method of one or more of Aspects 21-37.

Aspect 47: An apparatus for wireless communication, the apparatus comprising at least one means for performing the method of one or more of Aspects 21-37.

Aspect 48: A non-transitory computer-readable medium storing code for wireless communication, the code comprising instructions executable by one or more processors to perform the method of one or more of Aspects 21-37.

Aspect 49: A non-transitory computer-readable medium storing a set of instructions for wireless communication, the set of instructions comprising one or more instructions that, when executed by one or more processors of a device, cause the device to perform the method of one or more of Aspects 21-37.

Aspect 50: A device for wireless communication, the device comprising a processing system that includes one or more processors and one or more memories coupled with the one or more processors, the processing system configured to cause the device to perform the method of one or more of Aspects 21-37.

Aspect 51: An apparatus for wireless communication at a device, the apparatus comprising one or more memories and one or more processors coupled to the one or more memories, the one or more processors individually or collectively configured to cause the device to perform the method of one or more of Aspects 21-37.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and one or more processors, coupled to the one or more memories, configured to cause the UE to:
receive a configuration that indicates one or more uplink resource muting patterns based at least in part on one or more of a first physical uplink shared channel (PUSCH) resource mapping type or a second PUSCH resource mapping type; and transmit a PUSCH transmission in accordance with the one or more uplink resource muting patterns.

2. The apparatus of claim 1, wherein the one or more uplink resource muting patterns are per PUSCH resource mapping type, and wherein the PUSCH resource mapping type includes the first PUSCH resource mapping type or the second PUSCH resource mapping type.

3. The apparatus of claim 1, wherein the one or more processors, to receive the configuration, are configured to cause the UE to:
receive a serving cell configuration or an uplink bandwidth part configuration that indicates the one or more uplink resource muting patterns.

4. The apparatus of claim 1, wherein an uplink resource muting pattern, of the one or more uplink resource muting patterns, is associated with a frequency domain pattern and a time domain pattern, wherein the frequency domain pattern is a comb-2 like pattern, wherein the time domain pattern is different per PUSCH resource mapping type, and wherein a frequency location of an uplink resource muting is not configured, or is configured with one or more of: a starting physical resource block (PRB), an ending PRB, or a length.

5. The apparatus of claim 1, wherein the configuration indicates a first uplink resource muting pattern for the first PUSCH resource mapping type and a second uplink resource muting pattern for the second PUSCH resource mapping type.

6. The apparatus of claim 5, wherein:
the first uplink resource muting pattern for the first PUSCH resource mapping type is configured as one or two muted symbols per slot or per PUSCH; or
the second uplink resource muting pattern for the second PUSCH resource mapping type is configured as one or two muted symbols per slot.

7. The apparatus of claim 1, wherein the one or more processors are further configured to cause the UE to:
receive a PUSCH configuration that includes a time domain resource allocation (TDRA) table, wherein the TDRA table indicates the first PUSCH resource mapping type and the second PUSCH resource mapping type; and
apply an uplink resource muting pattern, of the one or more uplink resource muting patterns, to a plurality of PUSCH transmissions with the first PUSCH resource mapping type or the second PUSCH resource mapping type, or to a subset of PUSCH transmissions with the first PUSCH resource mapping type or the second PUSCH resource mapping type.

8. The apparatus of claim 1, wherein the one or more processors are further configured to cause the UE to:
transmit UE capability signaling that indicates that one uplink resource muting pattern per PUSCH resource mapping type is supported by the UE.

9. The apparatus of claim 1, wherein an uplink resource muting, associated with the one or more uplink resource muting patterns, is associated with an uplink rate matching.

10. The apparatus of claim 1, wherein the configuration indicates more than one uplink resource muting pattern for the first PUSCH resource mapping type and more than one uplink resource muting pattern for the second PUSCH resource mapping type.

11. The apparatus of claim 10, wherein:
the more than one uplink resource muting pattern for the first PUSCH resource mapping type is configured as one muted symbol before a demodulation reference signal (DMRS) symbol and one muted symbol after the DMRS symbol; or
the more than one uplink resource muting pattern for the second PUSCH resource mapping type is configured as two muted symbols after a front-loaded DMRS symbol.

12. The apparatus of claim 10, wherein the one or more processors are further configured to cause the UE to:
transmit UE capability signaling that indicates that more than one uplink resource muting pattern per PUSCH resource mapping type is supported by the UE, wherein the UE capability signaling indicates a number of uplink resource muting patterns that are supported per PUSCH resource mapping type, and wherein the UE capability signaling indicates a number of muted symbols per pattern, per PUSCH, or per slot that are supported by the UE.

13. The apparatus of claim 10, wherein the one or more processors are further configured to cause the UE to:
determine which uplink resource muting pattern, of the more than one uplink resource muting pattern for the first PUSCH resource mapping type and the more than one uplink resource muting pattern for the second PUSCH resource mapping type, is to be applied to a PUSCH with an associated PUSCH resource mapping type based at least in part on: an implicit rule depending on a PUSCH symbol length, radio resource control (RRC) signaling associated with a PUSCH configuration, or a time domain resource allocation (TDRA) table configuration,
wherein the TDRA table configuration is associated with a column entry or an RRC configured entry, wherein the column entry indicates the uplink resource muting pattern, and wherein the RRC configured entry indicates a pattern index associated with the uplink resource muting pattern.

14. The apparatus of claim 1, wherein the configuration indicates one uplink resource muting pattern for the first PUSCH resource mapping type and the second PUSCH resource mapping type, and wherein the one uplink resource muting pattern is configured as one or two muted symbols per slot or per PUSCH.

15. The apparatus of claim 1, wherein the configuration indicates a plurality of uplink resource muting patterns that are common for the first PUSCH resource mapping type and the second PUSCH resource mapping type, and wherein the plurality of uplink resource muting patterns are configured as a list of one or two muted symbols per slot or per PUSCH.

16. The apparatus of claim 15, wherein the one or more processors are further configured to cause the UE to:
determine which uplink resource muting pattern, of the plurality of uplink resource muting patterns, is to be applied to a PUSCH based at least in part on:
an implicit rule depending on a PUSCH symbol length, radio resource control (RRC) signaling associated with a PUSCH configuration, or a time domain resource allocation (TDRA) table configuration, wherein the TDRA table configuration is associated with a column entry or an RRC configured entry; and transmit UE capability signaling that indicates that the plurality of uplink resource muting patterns are supported by the UE, wherein the UE capability signaling indicates a number of uplink resource muting patterns that are supported by the UE, and wherein the UE capability signaling indicates a number of muted symbols per pattern, per PUSCH, or per slot that are supported by the UE.

17. The apparatus of claim 1, wherein an uplink resource muting pattern, of the one or more uplink resource muting patterns, is associated with a symbol index and a reference time location, wherein the symbol index is based at least in part on a bitmap or a symbol index number, wherein the reference time location is a first symbol of a slot, a first symbol of a PUSCH allocation, or a first demodulation reference signal (DMRS) of a PUSCH, and wherein the reference time location is same or different per PUSCH resource mapping type.

18. The apparatus of claim 1, wherein the one or more uplink resource muting patterns are excluded from being applied to certain uplink channels or reference signal types.

19. An apparatus for wireless communication at a network node, comprising:
one or more memories; and
one or more processors, coupled to the one or more memories, configured to cause the network node to:
transmit a configuration that indicates one or more uplink resource muting patterns based at least in part on one or more of a first physical uplink shared channel (PUSCH) resource mapping type or a second PUSCH resource mapping type; and receive a PUSCH transmission in accordance with the one or more uplink resource muting patterns.

20. A method of wireless communication performed by a user equipment (UE), comprising:
receiving a configuration that indicates one or more uplink resource muting patterns based at least in part on one or more of a first physical uplink shared channel (PUSCH) resource mapping type or a second PUSCH resource mapping type; and
transmitting a PUSCH transmission in accordance with the one or more uplink resource muting patterns.
